(19) United States
(12) Patent Application Publication
(10) Pub. No.: US 2026/0203571 A1
(43) Pub. Date: Jul. 16, 2026

(54) PIPELINE FOR GENERATING SYNTHETIC MULTILINGUAL TEXT AND AUDIO DATA FOR TRAINING SPEECH MODELS

(71) Applicant: Oracle International Corporation, Redwood Shores, CA (US)

(72) Inventors: Karan Dua, Najibabad (IN); Ranjeet Kumar Gupta, Bengaluru (IN); Nitin Benjamin Dasiah, Bangalore (IN)

(73) Assignee: Oracle International Corporation, Redwood Shores, CA (US)

(21) Appl. No.: 19/023,977

(22) Filed: Jan. 16, 2025

(51) Int. Cl. G06N 3/08; G06N 3/0475; G10L 13/02

(52) U.S. Cl. CPC G06N 3/08; G06N 3/0475; G10L 13/02

(57) ABSTRACT

Techniques are described for generating synthetic multilingual text and audio data for training speech models. In one aspect, a computer-implemented method is described that includes: generating, by a first generative artificial intelligence model, keyphrases for a domain, generating entities and associated normalized forms, generating, by a second generative artificial intelligence model, text scripts for the domain based on the keyphrases and the entities and their associated normalized forms, generating, by one or more audio models, audio associated with each of the text scripts, and training, using the text scripts and the audio associated with each of the text scripts, one or more machine learning models.

### FIELD

The present disclosure relates generally to training speech machine learning models, and more particularly, to techniques for generating synthetic multilingual text and audio data for training speech models.

### BACKGROUND

The advancement of digital communication technologies has led to the proliferation of devices and systems capable of processing and converting human speech into text and vice versa. These technologies have become integral to modern communication, enabling accessibility, enhancing productivity, and improving user experiences across a variety of applications, including personal computing, mobile devices, virtual assistants, and customer service systems.

Text-to-Speech (TTS) systems are designed to synthesize human-like speech from textual input, enabling machines to “speak” information to users. These systems are widely employed in scenarios where auditory feedback is preferred or necessary, such as accessibility tools for visually impaired individuals, navigation systems, and interactive voice response systems. Despite their utility, existing TTS systems often face challenges in achieving natural intonation, accurate prosody, and seamless integration with varying languages and dialects.

Speech-to-Text (STT) systems, on the other hand, convert spoken language into written text, enabling users to interact with devices through voice commands or dictation. These systems are widely utilized in transcription services, voice recognition interfaces, and applications requiring hands-free operation. However, current STT systems encounter limitations in accurately recognizing speech in noisy environments, distinguishing between multiple speakers, and handling diverse accents, languages, and contextual nuances.

As the demand for these technologies continues to grow, there remains a need for systems that can seamlessly integrate Text-to-Speech and Speech-to-Text functionalities in a manner that improves accuracy, adaptability, and user experience. Existing approaches often operate as standalone systems, lacking the ability to effectively interact with one another or adapt dynamically to user-specific requirements. Furthermore, both TTS and STT systems frequently rely on computationally intensive processes, which can hinder their deployment in resource-constrained environments such as mobile devices or embedded systems. Accordingly, there is a need for an improved Text-to-Speech and Speech-to-Text systems that address the above challenges, offering enhanced accuracy, naturalness, and efficiency while maintaining flexibility to accommodate diverse languages, accents, and use cases. Such systems would provide significant advancements in the fields of human-computer interaction, accessibility, and digital communication

### Summary

Described herein are embodiments (e.g., a method, a system, non-transitory computer-readable medium storing code or instructions executable by one or more processors) pertaining to techniques generating synthetic multilingual text and audio data for training speech models.

In various embodiments, a computer-implemented method is provided for that comprises: (a) generating, by a first generative artificial intelligence model, keyphrases for a domain; (b) generating entities and associated normalized forms; (c) generating, by a second generative artificial intelligence model, text scripts for the domain based on the keyphrases and the entities and their associated normalized forms; (d) generating, by one or more audio models, audio associated with each of the text scripts; and (e) training, using the text scripts and the audio associated with each of the text scripts, one or more machine learning models.

In some embodiments, generating the key phrases is an iterative process that comprises: determining whether a required number of keyphrases are available in a keyphrase store based on a current number or size of keyphrases stored in the keyphrase store and a predetermined threshold number or size of keyphrases to be generated and collected; when the required number of keyphrases are unavailable in the keyphrase store, generating, by the first generative artificial intelligence model, a keyphrase for the domain using multistep conversational prompting; evaluating a similarity of the keyphrase with each of the keyphrases stored in the keyphrase store; when the keyphrase is not similar to the keyphrases stored in the keyphrase store based on the evaluating, storing the keyphrase in the keyphrase store; and when the keyphrase is similar to at least one of the keyphrases stored in the keyphrase store based on the evaluating, skipping the keyphrase and proceeding back to generating, by the first generative artificial intelligence model, a keyphrase for the domain using the multistep conversational prompting.

In some embodiments, generating the entities and the associated normalized forms is an iterative process that comprises: determining whether a required number of entities have been generated based on an entity counter and a predetermined threshold number of entities to be generated and collected; when the required number of entities have not been generated, sampling an entity from a list of possible entities; identifying a type of semiotic entity required for the sampled entity; executing an entity provider associated with the type of semiotic entity required for the sampled entity, wherein the executing comprises generating a semiotic entity and a corresponding normalized form of the semiotic entity deterministically using a set of rules and one or more algorithms; and increasing the entity counter by one.

In some embodiments, the text scripts are generated by combining one or more of the keyphrases with one or more of the entities and forcing the second generative artificial intelligence model to generate the text scripts in a predefined type and format using a custom prompt for the predefined type and a library enforcer for the predefined format.

In some embodiments, the computer-implemented method further comprises: replacing the entities in the text scripts with the normalized forms associated with each of the entities; and normalizing, by a language model, any new entities within the text scripts that were generated by the second generative artificial intelligence model during the process of generating the text scripts.

In some embodiments, the computer-implemented method further comprises: determining whether a required number of the text scripts and the audio associated with each of the text scripts have been generated and collected for training the one or more machine learning models based on a datapoint counter and a predetermined threshold number of datapoints; when the required number of the text scripts and the audio associated with each of the text scripts have not been generated, generating additional text scripts and audio associated with each of the additional text scripts by executing steps (a)-(d) for the same domain or a different domain and increasing the datapoint counter by one for each additional text script and associated audio that is generated; when the required number of the text scripts and the audio associated with each of the text scripts have been generated, training, using the text scripts and the audio associated with each of the text scripts, the one or more machine learning models; prior to generating the audio associated with each of the text scripts, determining a validity of each of the text scripts based on integrity checks; when a text script is invalid based on the validity determination, the text script is removed from the method; and when the text script is valid based on the validity determination, the text script is kept in the method and the audio associated with text script is generated.

In some embodiments, generating the audio associated with each of the text scripts comprises: determining whether voice styling is needed based on defined configurations; when voice styling is needed, generating, by an audio styling model of the one or more audio models, the audio associated with each of the text scripts in the defined style and language; when voice styling is not needed, generating, by a base language audio model of the one or more audio models, the audio associated with each of the text scripts; determining whether voice cloning is needed based on defined configurations; when voice cloning is needed, cloning, by a cloning model of the one or more audio models and using a reference audio, a voice and modifying the audio associated with each of the text scripts in the defined style and language based on the cloned voice, and proceeding to perform step (e) using the text scripts and the audio with the cloned voice and with or without voice styling associated with each of the text scripts; and when voice cloning is not needed, proceeding to perform step (e) using the text scripts and the audio with or without voice styling associated with each of the text scripts.

Some embodiments of the present disclosure include a system including one or more data processors. In some embodiments, the system includes a non-transitory computer readable storage medium containing instructions which, when executed on the one or more data processors, cause the one or more data processors to perform part or all of one or more methods and/or part or all of one or more processes disclosed herein.

Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

FIG. 1 is an illustration of various inputs and outputs with ChatGPT in accordance with various embodiments.

FIG. 2 shows a block diagram of a pipeline framework comprised of a text generation pipeline for generating text data (i.e., text scripts), an audio generation pipeline for generating audio data (i.e., audio for associated text scripts), and a training and validation pipeline for training and validating one or more machine learning models in accordance with various embodiments.

FIG. 3 depicts a flowchart illustrating multistep prompting in accordance with various embodiments.

FIG. 4 depicts a flowchart illustrating multistep prompting and logit suppression (controlled generation) to generate keyphrases in accordance with various embodiments.

FIG. 5 depicts a flowchart illustrating checking for keyphrase duplication and storage of keyphrases in a keyphrase store in accordance with various embodiments.

FIGS. 6-8 depicts a flowchart illustrating an entity generation process in accordance with various embodiments.

FIG. 9 depicts a flowchart illustrating a text script generation process in accordance with various embodiments.

FIG. 10 shows a block diagram illustrating an AI platform for training and deploying models in accordance with various embodiments.

FIGS. 11A-11B show a block diagram illustrating an application for implementing a text and speech synthetic data generator in accordance with various embodiments.

FIG. 12 depicts a flowchart illustrating a process for generating text scripts and associated audio data to be used for training one or more machine learning models in accordance with various embodiments.

FIG. 13 is a block diagram illustrating one pattern for implementing a cloud infrastructure as a service system, according to at least one embodiment.

FIG. 14 is a block diagram illustrating another pattern for implementing a cloud infrastructure as a service system, according to at least one embodiment.

FIG. 15 is a block diagram illustrating another pattern for implementing a cloud infrastructure as a service system, according to at least one embodiment.

FIG. 16 is a block diagram illustrating another pattern for implementing a cloud infrastructure as a service system, according to at least one embodiment.

FIG. 17 is a block diagram illustrating an example computer system, according to at least one embodiment.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### INTRODUCTION

### Summary

Described herein are techniques provided within a complex pipeline framework comprised of a Keyphrase Sampler, An Entity Sampler capable of generating semiotic entities and their normalized form, a Text Script Generator, A Text Normalizer, and a Speech Audio Generator comprised of two components—a Style Controlled Text to Speech Generator and a Language Agnostic Tone Color Convertor. The techniques are capable of generating highly diverse, multilingual, domain specific text, its normalized form, style-controlled audio adapted to specific voice artists to enable voice standardization. Also disclosed, is an easy to use “playground” to assess the data generator and generate such data in bulk.

### Challenges Solved

One of the primary challenges faced by Text-to-Speech (TTS) and Speech-to-Text (STT) systems is the significant volume of training data required to achieve high levels of accuracy and naturalness. These systems rely on large datasets comprising textual inputs (i.e. text scripts) and their corresponding audio recordings to learn and replicate the complexities of human speech, including pronunciation, intonation, and contextual nuances. However, the availability of such data is often limited, particularly for specialized domains such as medical, financial, or technical fields. For instance, training a TTS system to read medical documents or an STT system to transcribe doctor-patient conversations requires highly specific datasets that include domain-specific terminology, unique linguistic structures, and formal language patterns. Such specialized data is rarely available in open-access repositories, making it challenging to develop systems that perform effectively in these contexts.

Another significant hurdle stems from the multilingual requirements of modern TTS and STT systems. To cater to a global audience, these systems must support a wide variety of languages, dialects, and accents. Each language not only requires its own unique dataset but also must account for regional variations in pronunciation, vocabulary, and syntax. Acquiring sufficient training data for less commonly spoken languages or regional dialects is particularly difficult, as publicly available resources are often sparse or nonexistent. Furthermore, even when datasets are available, they may lack the diversity needed to capture variations in speech patterns among different speakers, leading to biases in system performance. This lack of inclusivity can significantly impair the usability and accessibility of the systems for non-mainstream language users.

Licensing and legal restrictions further compound the data acquisition challenges. High-quality training datasets are often proprietary or protected by copyright, making them inaccessible for training and development without significant financial investment or legal agreements. Even publicly available datasets may come with restrictive licenses that limit their use in commercial applications. Additionally, privacy concerns and data protection regulations, such as the GDPR or CCPA, impose stringent requirements on the collection and use of speech data, particularly when it involves sensitive or personally identifiable information. These legal and regulatory barriers necessitate the development of alternative solutions, such as synthetic datasets or advanced data augmentation techniques, to overcome the inherent limitations in sourcing diverse and robust training data for TTS and STT systems.

### Overview of Embodiments and Solution for Challenges

A solution to address the aforementioned challenges and others faced by conventional TTS and STT systems is the development of a complex pipeline framework, which is capable of generating highly diverse, multilingual, domain specific text, its normalized form, and style controlled audio adapted to specific voice artists (i.e., training data-both textual and the corresponding speech). This framework incorporates several advanced components to generate diverse, multilingual, and domain-specific training data, as well as standardized speech outputs. The solution starts with a Keyphrase Sampler, which selects key linguistic elements and phrases based on specific domains or languages, ensuring that the generated data is highly relevant to the target use case, such as medical, financial, or technical contexts. Complementing this is an Entity Sampler, which creates “semiotic entities” (e.g., dates, times, numbers, and other structured data) and their normalized textual representations, facilitating the generation of text that closely mirrors real-world language use. These components ensure that the resulting datasets are not only domain-specific but also enriched with the linguistic complexity necessary for high-performing TTS and STT systems.

The pipeline further includes a Text Script Generator and a Text Normalizer, which work together to produce and refine textual data tailored to the needs of the system. Once the textual data is prepared, a Speech Audio Generator transforms it into high-quality audio, using two key subcomponents: a Style-Controlled Text-to-Speech Generator and a Language-Agnostic Tone Color Converter. The style-controlled TTS generator ensures that the synthesized speech adheres to specific stylistic or tonal requirements, such as those needed for formal medical, financial, or casual conversational contexts. Meanwhile, the tone color converter adds a layer of adaptability to individual voice artists for consistent output by enabling the system to modify speech characteristics across languages and accents without sacrificing naturalness or intelligibility. Since the downstream TTS systems may use specific voice characters, the tone color converter ensures that the data generated for these downstream systems have consistency in voice characters. It also ensures that even if a user does not have voice artists who can speak a specific language, the user can still clone their tone using reference audio from any language they can speak, thus helping scale the generation of training data. Together, these components create a flexible, scalable solution for generating robust, multilingual text datasets and corresponding standardized, high-quality audio outputs to be used as training data for TTS and STT systems, addressing the core limitations of existing training data and methods of procurement while significantly enhancing the accuracy, inclusivity, and usability of the TTS and STT systems trained with said training data.

In various embodiments, a computer implemented method is provided for that comprises: generating, by a first generative artificial intelligence model, keyphrases for a domain; generating entities and associated normalized forms; generating, by a second generative artificial intelligence model, text scripts for the domain based on the keyphrases and the entities and their associated normalized forms (in some instances, a second level of normalization is performed on the text scripts using another artificial intelligence model (e.g., a small language model)); generating, by one or more audio models, audio associated with each of the text scripts; and training, using the text scripts and the audio associated with each of the text scripts, one or more machine learning models. The one or more models may then be deployed as part of a TTS or STT system.

As used herein, the terms “about,” “similarly,” “substantially,” and “approximately” are defined as being largely but not necessarily wholly what is specified (and include wholly what is specified) as understood by one of ordinary skill in the art. In any disclosed embodiment, the term “about,” “similarly,” “substantially,” or “approximately” may be substituted with “within [a percentage] of” what is specified, where the percentage includes 0.1 percent, 1 percent, 5 percent, and 10 percent, etc. Moreover, the term terms “about,” “similarly,” “substantially,” and “approximately” are used to provide flexibility to a numerical range endpoint by providing that a given value may be slightly above or slightly below the endpoint without affecting the desired result.

As used herein, when an action is “based on” something, this means the action can be based at least in part on at least a part of the something.

### Text Scripts and Associated Challenges

Text scripts are specialized pieces of text designed to serve as input for TTS systems and as output for STT systems (e.g., input for training, fine-tuning, and implementing TTS and STT systems). These scripts are typically crafted with attention to the specific linguistic, grammatical, and contextual nuances of the domain they are intended to represent. For instance, a text script for a financial application might include financial aspects (e.g., financial reports, market analyses, or customer service dialogues), financial terminology (e.g., please transfer $1,000 from checking to savings), and structured text such as transaction records, stock market data, and financial reports. In contrast, a text script for a conversational virtual assistant might include informal dialogue, contractions, and colloquial expressions. By mirroring real-world usage, text scripts ensure that TTS systems can generate natural and contextually appropriate speech while enabling STT systems to accurately transcribe spoken language into meaningful text.

In addition to domain-specificity, text scripts account for variations in language, accent, and regional dialects to support multilingual and global applications. This requires the inclusion of diverse linguistic structures, idiomatic phrases, and cultural references to ensure inclusivity and usability across different user groups. Text scripts often include semiotic entities, such as dates, times, numbers, and acronyms, which require careful normalization to ensure that TTS systems pronounce them correctly and STT systems transcribe them accurately. For example, the date “Jan. 2, 2023” must be recognized and processed as “Jan. 2, 2023” in one context or “Feb. 1, 2023” in another, depending on regional conventions. By incorporating such considerations, text scripts serve as a foundation for training and evaluating the performance of TTS and STT systems, enabling them to meet the demands of diverse and complex real-world applications.

At first, it may seem like the required data for text scripts can be easily generated using a basic prompt, paired with the domain as an input, and for diversity, the sampling can be exploited. However, some basic prompting experiments reveal that Large Language Models such as Mistral have been tuned to generate text that is very similar when the input prompt doesn't change or substantially change. For example, for the prompt: “Construct one short sentence in the finance domain”, the following outputs (see Table 1) were generated when used with multiple sampling parameter values.

TABLE 1

| Temperature | top_p | Outputs (Generated 3 times with the same settings) | |
|---|---|---|---|
| 0.7 | 0.95 | 1. | Maintaining a budget surplus is essential for reducing debt and |
| | | | securing financial stability. |
| | | 2. | Maintaining a budget surplus can help reduce debt and ensure |
| | | | financial stability. |
| | | 3. | Maintaining a balanced budget is crucial for achieving financial |
| | | | stability. |
| 1.2 | 0.95 | 1. | Managing expenses effectively is crucial for maintaining a |
| | | | healthy financial situation. |
| | | 2. | Making regular investments in a diversified portfolio can help |
| | | | grow your wealth over time. |
| | | 3. | Maintaining a balanced budget is key to achieving long-term |
| | | | financial stability. |
| 1.2 | 0.51 | 1. | Maintaining a budget surplus is crucial for reducing debt and |
| | | | ensuring financial stability. |
| | | 2. | Maintaining a budget helps control your expenses and save for |
| | | | future financial goals. |
| 2.5 | 0.95 | 1. | A wiser investment Would have made twice your savings in a |
| | | | safer market stance. (Implying the reader missed an |
| | | | opportunity for increased returns by prioritizing safeguarded |
| | | | funds) |
| | | 2. | Exporting Savings: Despite decreased expenses, Investments |
| | | | yield higher returns, bolstering my financial security. |
| | | 3. | A sound financial plan includes creating a budget, building an |
| | | | emergency reserves, saving for retirement, and consistently |
| | | | reducing unnecessary debts. \nBut if you intend a single short |
| | | | sentence it would be- Investing as early and aggressively |
| | | | thanYou Can can enhance long-term returns significantly due |
| | | | toCompainddffects. |

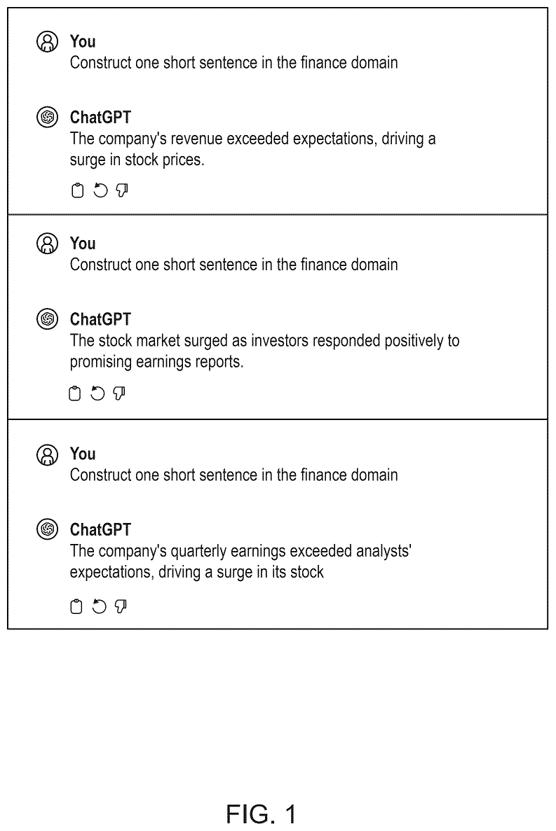

It is visible from the above examples that for lower values of temperature, the output is almost the same every time. For higher values of temperature, even though the text changes, the sub-domain is still limited to Personal Finance. Such high temperature values also effect model stability, and can lead to generation of garbage output, such as the example indicated in the last output. Similar behavior exists in closed-source commercial Large Language Models, such as GPT-3.5. The outputs shown in FIG. 1 demonstrate how the same prompt fed to ChatGPT (based on GPT-3.5 models) over multiple sessions resulted in very similar outputs.

### Normalization and Associated Challenges

The written form of text may be different from its spoken form. See for example, the text scripts and associate normalized form in Table 2.

TABLE 2

| Text Script | Normalized Form | Language |
|---|---|---|
| The best waffles in Delhi are found in the | The best waffles in Delhi are found in the | English |
| 10th St., Hauz Khas Vil. | tenth street, Hauz Khas Village in South | |
| | Delhi. | |
| El Dr. Johnson se especializa en el manejo | El Doctor. Johnson se especializa en el | Spanish |
| de enfermedades relacionadas con el estilo | manejo de enfermedades relacionadas con el | |
| de vida. | estilo de vida. | |
| Emily est née le Mar. 8, 1995. | Emily est née le trois août mil neuf cent | French |
| | quatre-vingt-quinze. | |

Generally, the difference in the written and spoken form is found in a specific set of entities and tokens such as address, dates, times, personal salutations. Such entities are known as Semiotic Entities.

A TTS system typically works by running the text through a Text Normalization System, while a Speech Recognition System works the other way round i.e., it denormalizes text to make it readable for the user. The process of normalization and denormalization enables these models to better estimate how a particular text token should be spoken or written. The conventional process of text normalization and denormalization involves passing the text through a rule based Pre-Post Processing system such as NVIDIA NeMo. However, a rule based Pre-Post Processing approach to text normalization is expensive and buggy. A text normalizer works by identifying the tokens which needs to be normalized, and then attempts to normalize them based on sets of rules. Since, this is a two-step rule-based Pre-Post Processing system, it doesn't know exactly how a piece of text was constructed and is often riddled with errors, resulting in poor normalization quality. Poor normalization would result in poor training data for downstream Pre-Post Processing systems. Such systems are adequate for inference (after training and deployment of models and systems), however for training or fine-tuning of models, there is a need to ensure that the synthesized training data is normalized without errors (or at least with as minimal errors as possible).

### Synthetic Multilingual Text and Audio Data Generation Pipeline

### Overview

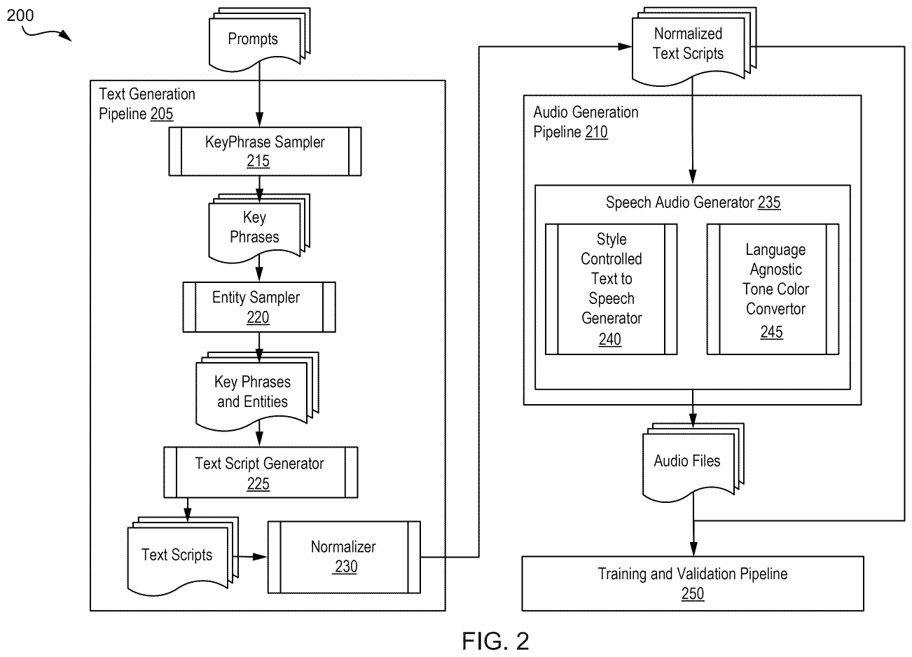

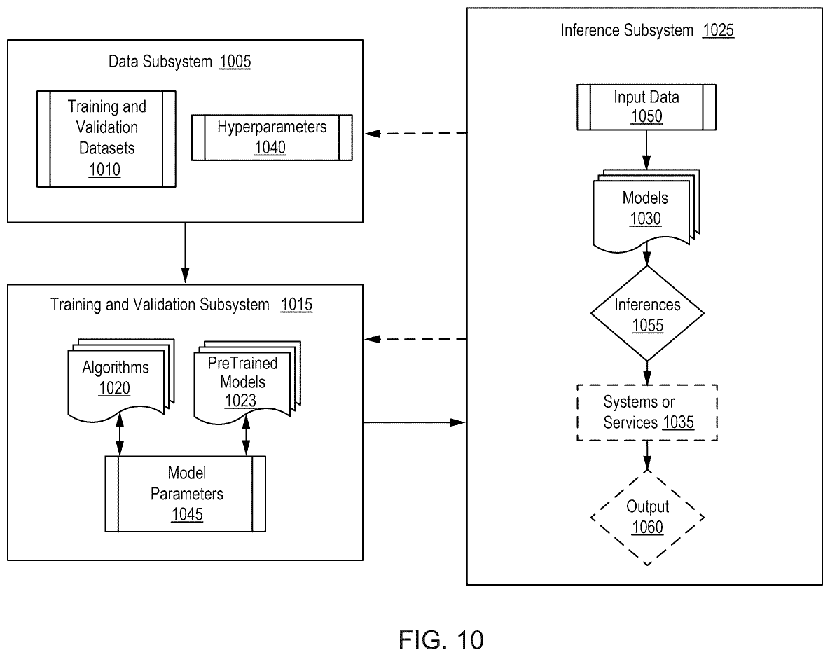

FIG. 2 shows pipeline framework 200 comprised of a text generation pipeline 205 for generating text data (i.e., text scripts), an audio generation pipeline 210 for generating audio data (i.e., audio for associated text scripts), and a training and validation pipeline 250 for training and validating one or more machine learning models. Together, these pipelines and the components thereof create a flexible, scalable solution for generating robust, multilingual text datasets and corresponding standardized, high-quality audio outputs to be used as training data for training and validating TTS and STT systems (see description with respect to FIG. 10).

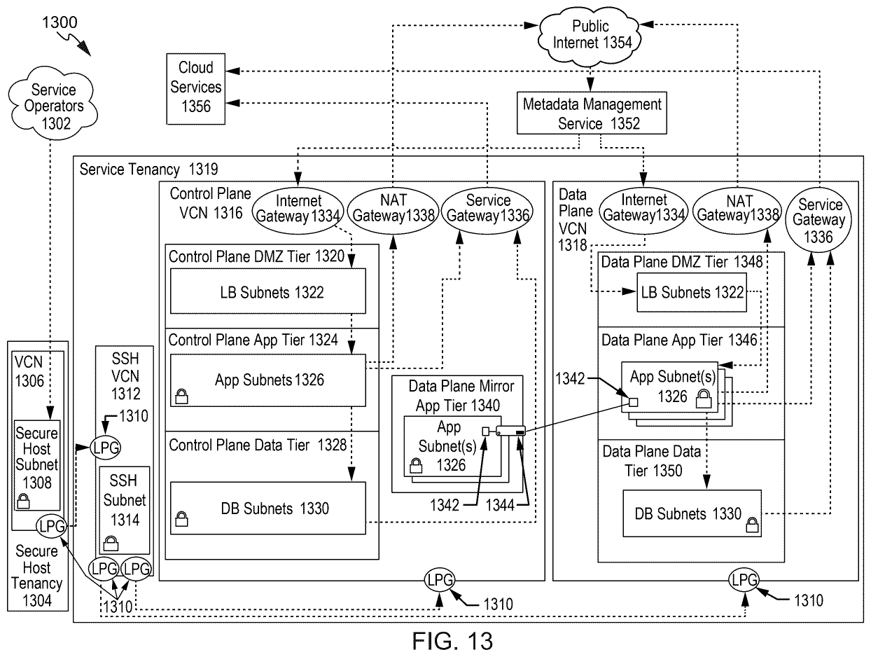

The text generation pipeline 205 comprises a Keyphrase Sampler subsystem 215 capable of generating keyphrases by prompting a Large Language Model (LLM), an Entity Sampler subsystem 220 capable of generating semiotic entities and their normalized forms, a Text Script Generator subsystem 225 capable of generating text scripts based on the keyphrases, the semiotic entities and their normalized forms, and A Text Normalizer subsystem 230 capable of normalizing the text scripts. The audio generation pipeline 210 comprises a Speech Audio Generator subsystem 235 comprised of two components—a Style Controlled Text to Speech Generator 240 and a Language Agnostic Tone Color Convertor 245. The Style Controlled Text to Speech Generator 240 is capable of generating audio for a text script styled as per a style prompt. The Language Agnostic Tone Color Convertor 245 is capable of generating a speech audio styled as output from the Style Controlled Text to Speech Generator 240, while sounding like a reference audio. The various subsystems of pipeline framework 200 are executed as part of an application using one or more on-premises systems (e.g., one or more computing devices configured to implement functionality associated with the subsystems) and/or offered as a cloud computing service, as described in detail with respect to FIGS. 13-17. For example, infrastructure as a service (IaaS) is one particular type of cloud computing. IaaS can be configured to provide virtualized computing resources over a public network (e.g., the Internet) configured to implement functionality associated with the subsystems.

### Keyphrase Sampler

As discussed above, if there isn't enough diversity in the inputs to a Large Language Model (LLM), the model continues to generate repetitive data. One way to improve text diversity is by infusing the input with some keyphrases. For example, instead of prompting the model “Generate a sentence in finance domain”, the model can be prompted to “Generate a sentence in finance domain containing the following keyphrases: Mortgage, Asset Finance”. Further, the model can be prompted to generate text with multiple such keyphrase combinations to ensure higher diversity in the generated text. However, gathering such domain specific keyphrases is a challenge in itself. To address this challenge, the model can be prompted to initially generate the keyphrases, but it will again suffer from repetitiveness if some other approach isn't followed.

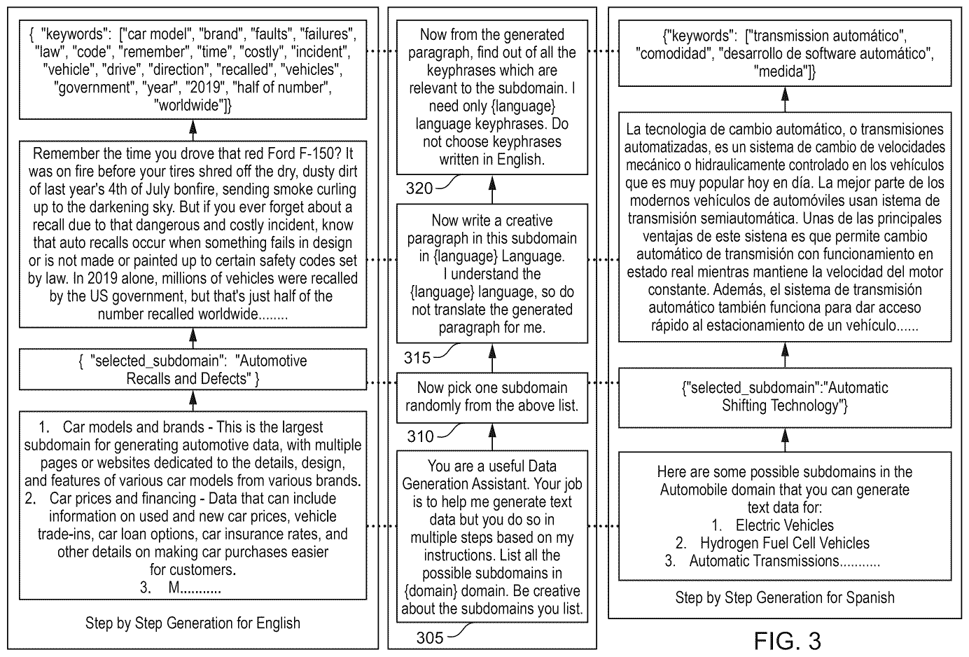

To address this challenge, a multistep prompting technique is used to generate the keyphrases via a keyphrase sampler (e.g., Keyphrase Sampler subsystem 215). More specifically, instead of prompting one or more LLMs (e.g., Mistral) of the keyphrase sampler to generate some keyphrases directly, a step-by-step process using multiple prompts is used to generate domain specific keyphrases. As shown in FIG. 3, the first prompt 305 may include: “You are a useful Data Generation Assistant. Your Job is to help me generate text data, but you do so in multiple steps based on my instructions. List all possible subdomains in {domain} domain. Be creative about the subdomains you list.” In some instances, the following domains may be present in the framework to facilitate keyphrase generation: [‘Automobile’, ‘Banking’, ‘Finance’, ‘Business And Industry’, ‘Computers And Electronics’, ‘Food And Grocery’, ‘Government’, ‘Politics’, ‘Law’, ‘Health And Medical’, ‘Internet And Communications’, ‘Retail And Shopping’, ‘Aviation’, ‘Aerospace’, ‘Gaming’, ‘Hospitality’]. The prompts may also contain instructions to generate keyphrases in a specific language and as (prompts for both English and Spanish keyphrase generation are shown in FIG. 3). The next prompt 310 may include: “Now pick one subdomain randomly from the above list.”. The next prompt 315 may include: “Now write a creative paragraph in this subdomain in {language} language, so do not translate the generated paragraph for me.”. The next prompt 320 may include: “Now from the generated paragraph, find out of all the keyphrases which are relevant to the subdomain. I need only {language} language keyphrases. [if language other than English]-Do not chose keyphrases written in English.”. This prompting technique may be repeated until enough number of keyphrases (e.g., predetermined number n indicative of total number of keyphrases in the keyphrase store or a memory size consumed by the keyphrases in the keyphrase store) are generated for a requested language and domain.

### Logit Suppression for Controlled Output

It may be difficult to ensure that the outputs of the one or more LLMs adhere to a specific output format using just the prompt. For example, when an LLM is prompted to generate some keyphrase, it may generate some additional preceding and succeeding text as well such as—“Sure, here are some keyphrases from the automobile domain . . . <keyphrases> Let me know if you need some more help”. Such text is difficult to parse and get rid of, even if a user prompts the LLM explicitly to avoid generating such text.

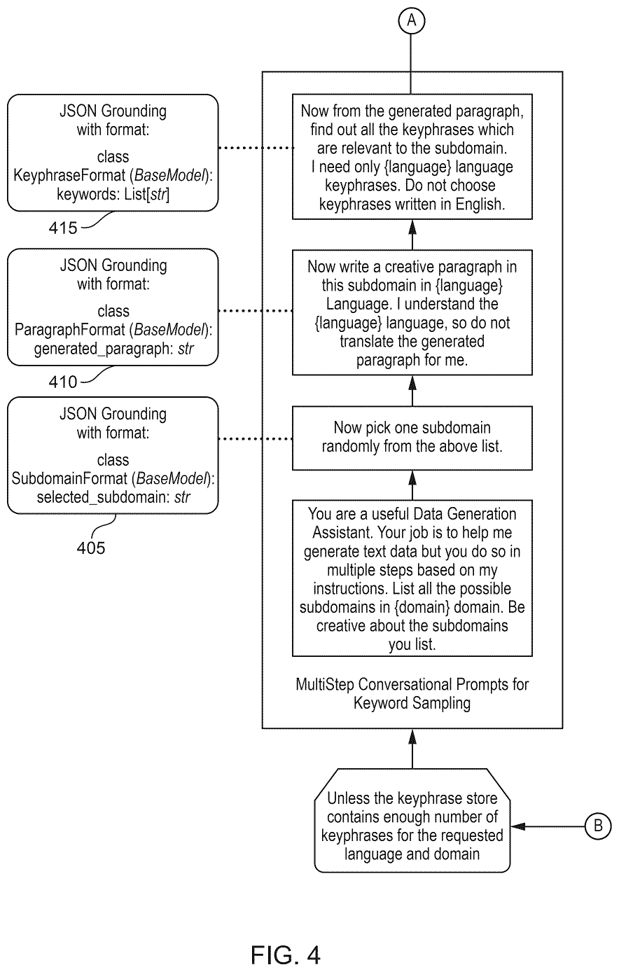

An LLM generates outputs by generating numbers called “logits”, one for each token. After the logits are generated, the LLM applies a softmax function to find probabilities of the tokens and their corresponding probabilities. To force the one or more LLMs to generate a specific token, a logit corresponding to that specific token can be set to a high value and all other logits can be set to zero. This ensures that the desired token to be generated has the highest value. For example, a, enforcement library could be used such as LM Format Enforcer which enforces the output format (JSON Schema, Regex etc.) of a language model. Instead of just “suggesting” the desired output structure to an LLM, an enforcement library such as LM Format Enforcer can actually “force” the LLM output to follow the desired schema. Thus, enabling the capability to parse the generated domain and language specific keyphrases seamlessly. The enforcement library works by combining a character level parser with a tokenizer prefix tree to allow only the tokens which contains sequences of characters that lead to a potentially valid format. As shown in FIG. 4, the enforcement library can be applied at multiple prompting steps (e.g., 405, 410, and 415) of the multistep prompting technique described above to “force” the LLM output to follow the desired schema for each prompt.

### Keyphrase Store and De-Duplication

An in-memory keyphrase store may be utilized to store the domain and language specific keyphrases. A Fuzzy Search may also be used based on a string metric for measuring the difference between two sequences such as Token Sort Ratio and Levenshtein Distance to make sure that keyphrases that are very similar to each other are not stored. Alternatively, the Fuzzy Search may be replaced with a keyphrase Embeddings Model such as PhraseBERT, where the similarity between the keyphrases is determined by first extracting the keyphrase embeddings, then computing similarity (e.g., semantic similarity) with the existing keyphrases in the keyphrase store, and then deciding whether the keyphrase should be stored or not based on the similarity to make sure that keyphrases that are very similar to each other are not stored.

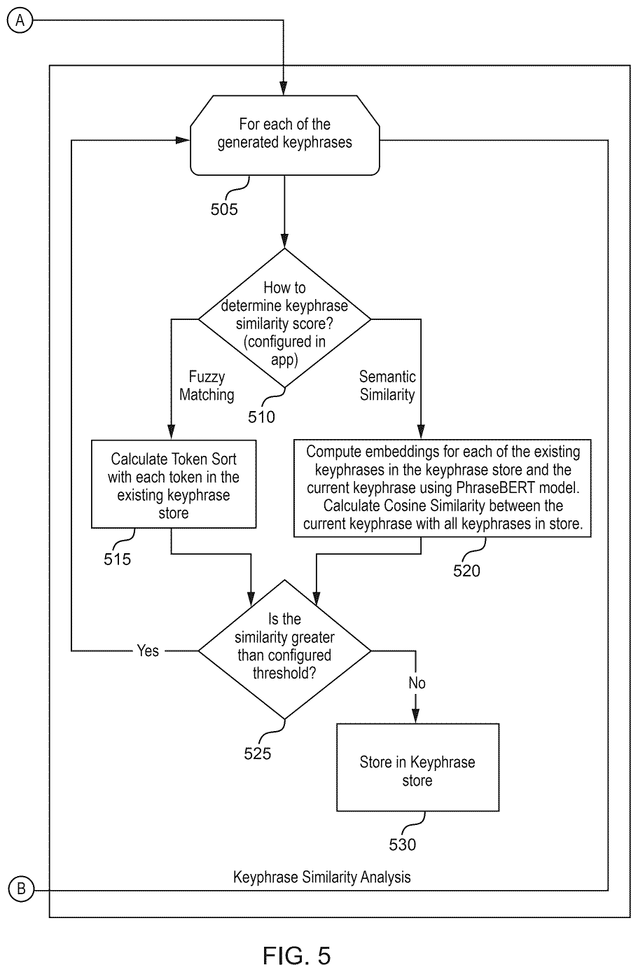

As shown in FIG. 5, at step 505 the generated keyphrases are received from the keyphrase sampling and logit suppression process (A). For each of the generated keyphrases, a determination is made at step 510 on the search or matching technique to use for determining a similarity score for the keyphrase. The search or matching technique may be configurable in the application and thus the determination may be made based on a user defined configuration. When the determination is to perform a first search or matching technique such as Fuzzy Search, the process proceeds at step 515 for execution of the first search or matching technique based on the generated keyphrase and each existing keyphrase in the in-memory keyphrase store. Fuzzy search is a technique used to approximate string matching, allowing for the identification of similar but not necessarily identical text strings (e.g., comparison between the generated keyphrase and each existing keyphrase in the in-memory keyphrase store). Two commonly used algorithms in fuzzy search are Levenshtein Distance and Token Sort Ratio, both of which help measure how closely two strings resemble each other effectively generating a similarity score. Levenshtein Distance calculates the minimum number of single-character edits (insertions, deletions, or substitutions) required to transform one string into another. For example, the distance between “cat” and “bat” is 1, as only one substitution is needed. This metric is particularly useful for detecting small typographical errors or spelling variations. On the other hand, Token Sort Ratio, an enhancement used in libraries like FuzzyWuzzy, focuses on comparing strings while accounting for word order differences. It works by tokenizing the strings (breaking them into words), sorting the tokens alphabetically, and then calculating their similarity using a method like Levenshtein Distance. This ensures that strings with the same words in a different order (e.g., “Oracle Cloud” and “Cloud Oracle”) are still recognized as highly similar.

When the determination is to perform a second search or matching technique such as a keyphrase Embeddings Model, the process proceeds at step 520 for execution of the second search or matching technique based on the generated keyphrase and each existing keyphrase in the in-memory keyphrase store. Embeddings models like PhraseBERT work by transforming text into dense, high-dimensional vector representations (embeddings) that capture the semantic meaning of the text. PhraseBERT, specifically, is a variation of the BERT (Bidirectional Encoder Representations from Transformers) architecture fine-tuned for sentence or phrase-level similarity tasks. When comparing two strings (e.g., comparison between the generated keyphrase and each existing keyphrase in the in-memory keyphrase store), the model encodes each string into its respective vector in a shared embedding space, where semantically similar strings are mapped closer together, and dissimilar strings are mapped farther apart. The similarity between the two embeddings is then measured using metrics such as cosine similarity, which calculates the cosine of the angle between the vectors to generate a similarity score. This approach captures not just lexical similarity (e.g., shared words) but also semantic relationships, making it particularly effective for determining similarity between phrases that may differ in wording but convey the same meaning. For instance, “company's revenue exceeded expectations” and “Oracle's revenue was greater than expected” would yield highly similar embeddings, even though they use different words.

At step 525, a determination is made as to whether the similarity score determined in step 515 or 520 is greater than a predetermined similarity threshold. The predetermined similarity threshold may be configurable in the application and thus the determination may be made based on a user defined configuration. When the determination is that the similarity score determined in step 515 or 520 is greater than the predetermined similarity threshold, the process does not store the generate keyphrase in the in-memory keyphrase store and proceeds back to step 505 to process the next keyphrase generated by keyphrase sampling and logit suppression process (A). When the determination is that the similarity score determined in step 515 or 520 is less than or equal to the predetermined similarity threshold, the process does store the generate keyphrase in the in-memory keyphrase store at step 530 and returns to step 505 to process the next keyphrase generated by keyphrase sampling and logit suppression process (A). At step 505, if there are no more generated keyphrases to be processed and/or the when the in-memory keyphrase store contains enough number of keyphrases for the requested language and domain, the key phrase similarity analysis process ends (see below description of further processing by the pipeline framework. However, if there are more generated keyphrases to be processed and/or the when the in-memory keyphrase store does not contain enough number of keyphrases for the requested language and domain, the keyphrase sampling and logit suppression process continues at (B). A determination of whether the in-memory keyphrase store does or does not contain enough number of keyphrases may be based on a predetermined threshold number of keyphrases to be generated and collected for the training purposes of the LLM. This threshold number may be determined based on a length of the text scripts desired by a user and is indicative of a total number of keyphrases in the keyphrase store or a memory size consumed by the keyphrases in the keyphrase store. For example, if the user desires that the text scripts have a longer length, then the user will want to generate more keyphrases and thus the threshold number for the total number of keyphrases or a memory size consumed by the keyphrases should be set higher. The predetermined threshold number of keyphrases may be configurable in the application and thus the determination may be made based on a user defined configuration.

Entity Sampler—Semiotic Entities and their Normalized Form

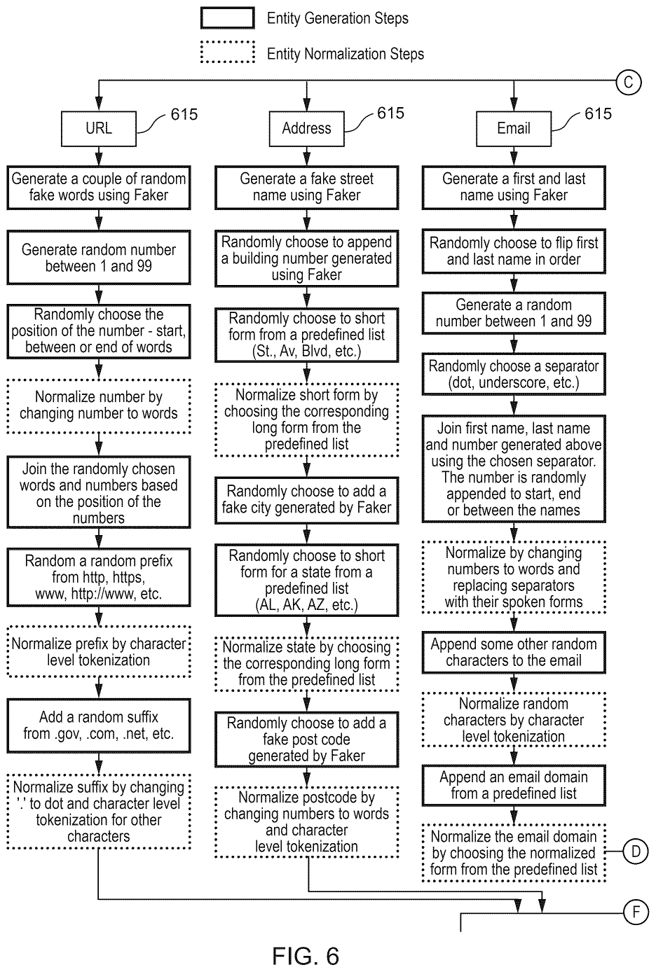

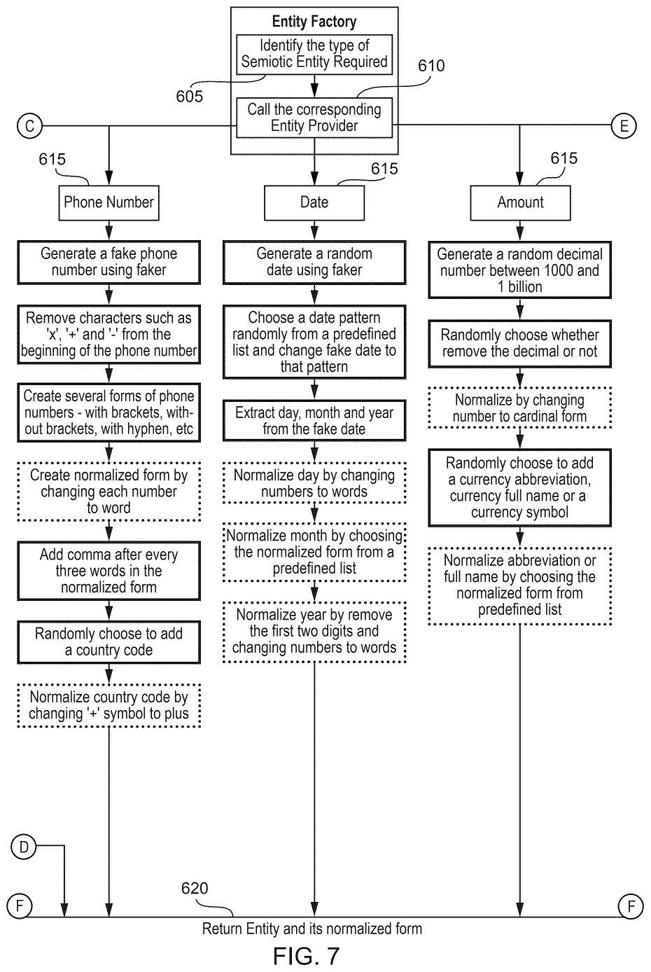

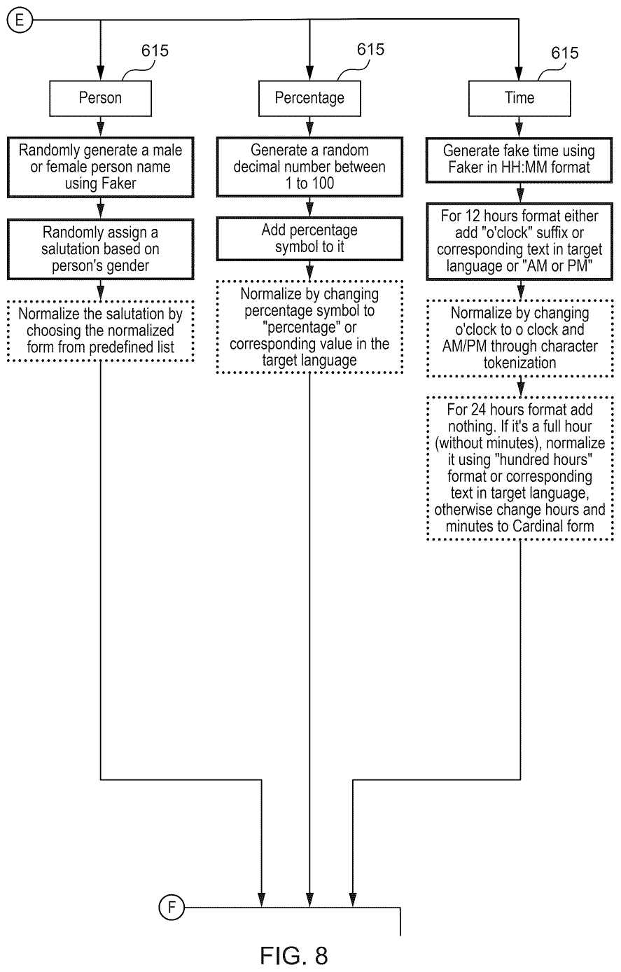

As mentioned above, generally the difference in the written and spoken form is found in a specific set of entities and tokens such as address, dates, times, personal salutations. The entity generator (e.g., Entity Sampler subsystem 220 described with respect to FIG. 2) generates not just the entities but also their normalized forms. Such generation is deterministically possible using a set of rules with guaranteed accuracy in normalization, since these entities are not yet part of the final text. As shown in the chart depicted across FIGS. 6-8, one or more different forms of entities (e.g., semiotic entities) are sampled at step 605 from a list of potential entities. At step 610, a corresponding entity provider (subsystem or module) is called for each of the one or more identified different forms of entities. At steps 615, corresponding entity provider(s) generate the entities and their normalized forms via a series of rules and algorithms based on the entity type and target language. For example, for the entity type of Person and a given target language, the Person provider first generates a male or female person name using a data generation algorithm such as Faker (Faker is a library that generates fake (but reasonable) data), and then the Person provider randomly assigns a salutation based on the person's gender. For normalization of the person entity types, the Person provider normalizes the salutation by choosing the normalize form from a predefined list of salutations. At step 620, the entity and its normalized version are returned for downstream processing (see Tables 3 and 4 for examples of sample entities and normalized forms in English and Spanish).

TABLE 3
In English

| S.No | Type | Generated Entity | Normalized Form |
|---|---|---|---|
| 1 | Amount | 863k Canadian Dollars | Eight Hundred and Sixty Three Thousand |
| | | | Canadian Dollars |
| | | 29 USD | Twenty Nine U S Dollars |
| | | 723m £ | Seven hundred and twenty three million pounds |
| 2 | Date | Oct. 4, 2023 | October forth twenty twenty three |
| | | Oct. 21, 1997 | October twenty first ninety seven |
| | | 6 Jan. 2010 | January sixth ten |
| 3 | Person | Dr. Yvette Nelson | Doctor Yvette Nelson |
| | | Mr. Cameron Carter | Mister Cameron Carter |
| | | Mrs. Julia Thomas | Missiz Julia Thomas |
| 4 | Email | cbrwthomaswalker29@hotmail.com | c b r w thomas walker two nine at hot mail dot com |
| | | 151sonyasanders@mail.com | 1 five one sonya sanders at mail dot com |
| 5 | Phone | 7854017402 | seven eight five, four zero one, seven four zero |
| | Number | | two |
| | | +1-47859964121 | plus one, four seven eight five, nine nine six, four |
| | | | one two one |
| 6 | Percentage | 39.29% | thirty nine point two nine percent |
| 7 | URL | http://though15.eu | h t t p colon slash slash though one five dot e u |
| 8 | Address | Johnson Trail Plz KY 45287 | Johnson Trail Plaza Kentucky four five two eight |
| | | | seven |
| | | Chen Inlet North Dakota | Chen Inlet North Dakota three four one zero one |
| | | 34101 | |
| 9 | Time | 13:59 | Thirteen fifty nine |
| | | 17:00 | Seventeen hundred hours |
| | | 02:34 PM | two thirty four P M |
| | | 11 o'clock | eleven o clock |

TABLE 4
In Spanish

| S. | | | |
|---|---|---|---|
| No | Type | Generated Entity | Normalized Form |
| 1 | Amount | CA$572 | quinientos setenta y dos Dólares Canadienses |
| | | A$485,986,561.71 | cuatrocientos ochenta y cinco millones |
| | | | novecientos ochenta y seis mil quinientos |
| | | | sesenta y uno punto siete uno Dólares |
| | | | Australianos |
| | | 723m £ | 723 millones de libras |
| 2 | Date | May 22, 1993 | mayo vigésimo segundo noventa y tres |
| | | Oct. 2, 1988 | octubre segundo mil novecientos ochenta y ocho |
| | | Aug. 4, 2000 | abril octavo dos mil |
| 3 | Person | Prof. Edgardo Aragón Trujillo | El Profesor Edgardo Aragón Trujillo |
| | | Dr. Bernabé Quintanilla | El Doctor Bernabé Quintanilla Cerezo |
| | | Cerezo | |
| | | Sr. Rodolfo del Cid | Señor Rodolfo del Cid |
| 4 | Email | 16rosaliaquesada@outlook.com | uno seis rosalia quesada at outlook dot com |
| | | ferreraclara36@outlook.com | ferrera clara tres seis at outlook dot com |
| 5 | Phone | 4 835600765 | cuatro ocho tres, cinco seis cero, cero siete seis |
| | Number | | cinco |
| | | 4807 14 77 34 | cuatro ocho cero, siete uno cuatro, siete siete tres |
| | | | cuatro |
| 6 | Percentage | 69.76% | sesenta y nueve punto siete seis por ciento |
| | | 76% | setenta y seis por ciento |
| 7 | URL | 73corporis.gov | siete tres corporis dot gov |
| 8 | Address | 79 Pasaje de Claudio Jimenez | siete nueve Pasaje de Claudio Jimenez Aldea |
| | | Vlg Tarragona Colorado | Tarragona Colorado uno uno dos ocho dos |
| | | 11282 | |
| | | Pasadizo Julián Bosch | asadizo Julián Bosch Louisiana tres dos uno |
| | | Louisiana 32198 | nueve ocho |
| 9 | Time | 09:20 | nueve veinte |
| | | 07:59 pm | siete cincuenta y nueve p m |
| | | las 2 en punto | las dos en punto |

### Text Script Generator

The Text Script Generator subsystem (e.g., the Text Script Generator subsystem 225 described with respect to FIG. 2) generates domain specific text scripts by combining the keyphrases generated as described with respect to FIGS. 3, 4, and 5 with the semiotic entities generated as described with respect to FIGS. 6, 7, and 8. The Text Script Generator subsystem comprises one or more LLMs for generating the domain specific text scripts. As described above, an enforcement library may be used such as LM Format Enforcer to force the one or more LLMs to generate the text in a given format such as a JSON format. This ensures that the one or more LLMs generate only the required text scripts (e.g., utterance) and nothing else. Additionally, the semiotic entities may be replaced in the text scripts with their normalized forms to generate a normalized form of the text scripts. The following types of text scripts may be generated: \[‘statement’, ‘exclamation’, ‘question’, ‘phrase’, ‘utterance from a conversation’]. The normalized text is post-processed to reduce normalization errors. A different prompt may be used for each type of text script.

### Multilingual Text to Text Generation Model for Second Level of Text Normalization

The above text generation process can ensure 100% correctness in normalization for the semiotic entities injected as part of the data generation process. However, since the text generated by the one or more LLMs is free form text, it may be comprised of other text and entities which are not normalized. Since such entities were not part of the initial prompt to the model, it is difficult to detect such entities in the generated text and normalize them. To mitigate this issue, human review may be used on a subset of generated samples containing normalization errors due to newly encountered entities, the subset of generated samples may be normalized manually and a smaller Language Model such as a multilingual text to text generation model (e.g., mT5) may be used to identify and generate normalized text based on such entities. This is a unique use case, where the text scripts may have entities which are correctly normalized while also having normalization errors. In some instances, data subsets from all the target languages may be used to train the Language Model. Table 5 shows training samples for a few normalization errors encountered in the generated text scripts from the text generation process.

TABLE 5

| Normalized Text after | | |
|---|---|---|
| Postprocessing | Correct Normalized form | Reason for Normalization Error |
| Can we use that to create a | Can we use that to create a | Postprocessing ensures that any capital |
| reliable and secure | reliable and secure | letters are character tokenized. However, |
| network for our V o I P | network for our V o I P and | in this case, Sms, although was an |
| and Sms | S M S communications? | abbreviation, couldn't be detected as a |
| communications? | | capitalized word, and was therefore |
| | | skipped. |
| Mister. Joseph Matthew's | Mister. Joseph Matthew's | The entity used to generate the text was |
| business had a revenue of | business had a revenue of | only Mr. Joseph Matthew, which got |
| $200k last year. | 200 thousand dollars last | normalized correctly. However, the LLM |
| | year. | also generated an additional semiotic |
| | | entity −$200k, which couldn't be identified |
| | | and normalized |
| The government collected | The government collected | The postprocessing step expands all |
| taxes worth | taxes worth | numbers. However, in this case, a cardinal |
| $1.2B while being at a | $1.2B while being at a | form of the number 12 was required, |
| deficit of one two percent. | deficit of twelve | which cannot be automatically identified. |
| | percent. | |

The training data may be prepared in the format shown in Table 6 for training the Language Model. The samples may be chosen based on the type of normalization error, the semiotic entity with the normalization error, and the target language.

TABLE 6

| Input to the Model | Expected Output from the Model |
|---|---|
| Can we use that to create a reliable and | Can we use that to create a reliable and secure network |
| secure network for our V o I P and Sms | for our V o I P and S M S communications? |
| communications? | |
| Mister. Joseph Matthew's business had a | Mister. Joseph Matthew's business had a revenue of |
| revenue of $200k last year. | 200 thousand dollars last year. |
| The government collected taxes worth $1.2B | The government collected taxes worth $1.2B while |
| while being at a deficit of one two | being at a deficit of twelve percent. |
| percent. | |

In some instances, more training data can also be automatically created after human review. For example, after human review, for the samples which were correct, the correct text scripts can be perturbed. For example, the sentence: “There was a 12% year on year growth in the fashion industry” can be automatically perturbed to “There was a one two percent year on year growth in the fashion industry” as an input sequence and “There was a twelve percent year on year growth in the fashion industry” can be automatically retrieved or generated as the output sentence. The subsystem has the capability to do this because all the details about the original sentence are retained by the subsystem such as the kind of semiotic entities and where they exist in the sentence. This can help scale the training data even more apart from what were found to be incorrect by human reviewers. Additionally, the subsystem can also keep at least some of the correctly normalized sentences in the training data so that during inference, the trained models do not accidentally end up incorrectly normalizing sentences which were already 100% correct.

### Full Text Generation Pipeline

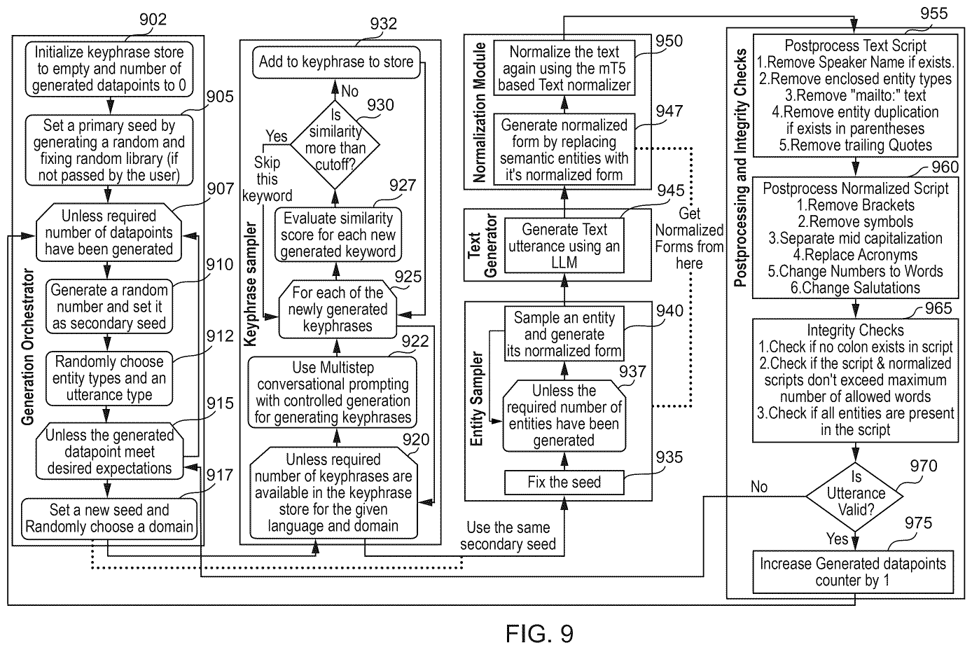

FIG. 9 shows the full text generation pipeline as executed by the subsystems and application (e.g., text generation pipeline 205 described with respect to FIG. 2). At step 902, the in-memory keyphrase store is initialized to empty and the number of generated datapoints (i.e., keyphrases) is set to zero (datapoint counter). At step 905, a primary seed is set by generating a random number or fixing the random library. A seed is an initial value provided to the algorithm that generates random numbers. Random number generators (RNGs) in programming are typically pseudorandom, meaning they rely on deterministic algorithms to produce numbers that seem random. The seed determines the starting point of this sequence. The primary seed is the main input used to initialize the random number generator. It ensures that the sequence of generated numbers is reproducible. For example, if the primary seed is set to 12345, the subsystem always obtains the same sequence of random numbers every time the program is run with that seed. In some instances, a secondary seed may be used as an additional parameter to influence or diversify the random sequence. This can be done to add another layer of randomness or to generate numbers for different streams while maintaining some correlation between them. When the seed is randomly generated, this means the program uses some unpredictable external factor (e.g., the current system time, user input, or hardware state) to create the seed value. This makes the sequence of random numbers less predictable. “Fixing” the random library refers to setting a predetermined seed value (as opposed to randomly generating one). This may be done if a user has predefined a value for the seed in the application. By fixing the random library with a specific seed, it is assured that the same sequence of random numbers is generated every time the program runs.

The purpose of using seeds is to ensure reproducibility. The primary seed is set to maintain consistency in the sequence of secondary seeds. For instance, if the primary seed is set to a value x, and it generates secondary seeds y and z, reusing the primary seed x in the future will regenerate the same secondary seeds y and z. This ensures the reproducibility of outcomes. Users can either provide the primary seed or let the algorithm generate one. In the latter case, the generated primary seed can be reused to reproduce the same results later. Regarding the use of two separate kinds of seeds: Two secondary seeds may be used at specific points in the process. First, the secondary seed used at step 910 ensures that the entity and utterance type of a new data point remain consistent if a data point is discarded. It also ensures that if a valid data point is generated, the next one will have different entity and utterance types, maintaining variety in the generated data. If the primary seed is used directly, every datapoint would have had the same set of entity and utterance types. So, the first secondary seed is implemented inside the loop (907). Second, the secondary seed used at step 917 ensures that a discarded data point does not result in generating the same data point repeatedly. This introduces variation after a discard, preventing duplication. If the primary seed or the first secondary seed would have been used, the newly generated datapoint after discarding would have been the same as the previously discarded one. So, the second secondary seed is implemented inside the loop (915). This structured use of seeds ensures reproducibility, variation, and efficient handling of discarded data points.

At step 907, unless the required number of datapoints (text scripts) have been processed/generated, the orchestration process continues at step 910. However, when the required number of datapoints (text scripts) have been processed/generated, the orchestration process stops. At step 910, a secondary seed (first secondary seed) is set by generating a random number or fixing the random library as described above to generate independent variations for sub-processes. In some instances, the secondary seed is used to set the number of entities to be generated for a given domain. At step 912, entity types and an initial type of text script are randomly selected. At step 915, unless the generated datapoint (text script) meets expectations (see postprocessing and integrity checks block), the orchestration process proceeds to step 917. However, when the generated datapoint (text script) meets expectations (see postprocessing and integrity checks block), the orchestration process proceeds back to step 907.

At step 917, a new a secondary seed (second secondary seed) is set by generating a random number or fixing the random library, and a domain is randomly selected. In some instances, the following domains may be present in the framework for random selection to facilitate keyphrase generation: [‘Automobile’, ‘Banking’, ‘Finance’, ‘Business And Industry’, ‘Computers And Electronics’, ‘Food And Grocery’, ‘Government’, ‘Politics’, ‘Law’, ‘Health And Medical’, ‘Internet And Communications’, ‘Retail And Shopping’, ‘Aviation’, ‘Aerospace’, ‘Gaming’, ‘Hospitality’].

At step 920, unless the required number of keyphrases are available in the keyphrase store for the given language and domain, the key phrase sampler and similarity analysis process continues at step 922. However, when the required number of keyphrases are available in the keyphrase store for the given language and domain, the process continues at step 935 with entity sampling. A determination of whether the required number of keyphrases are available in the keyphrase store may be based on a predetermined threshold number (e.g., based on a length of text scripts a user needs for training the downstream model) of keyphrases to be generated and collected for the training purposes of the LLM. The predetermined threshold number of keyphrases may be configurable in the application and thus the determination may be made based on a user defined configuration.

At step 922, the multistep prompting technique described above (keyphrase sampling and logit suppression process) is executed to cause the one or more LLMs in a controlled manner to generate keyphrases. At step 925, for each generated keyphrase, the similarity analysis described above is executed to generate similarity scores between each generated keyphrase and the keyphrases within the in-memory keyphrase store. At step 927, the generated similarity score is evaluated for each generated keyphrase. At step 930, a determination is made as to whether the similarity score determined and evaluated in steps 925 and 927 is greater than a predetermined similarity threshold. The predetermined similarity threshold may be configurable in the application and thus the determination may be made based on a user defined configuration. When the determination is that the similarity score determined and evaluated in steps 925 and 927 is greater than the predetermined similarity threshold, the process does not store the generate keyphrase in the in-memory keyphrase store and proceeds back to step 925 to process the next keyphrase generated by keyphrase sampling and logit suppression process. When the determination is that the similarity score determined and evaluated in steps 925 and 927 is less than or equal to the predetermined similarity threshold, the process does store the generate keyphrase in the in-memory keyphrase store at step 932 and returns to step 925 to process the next keyphrase generated by keyphrase sampling and logit suppression process.

As described above if there are no more generated keyphrases to be processed and/or the when the in-memory keyphrase store contains enough number of keyphrases for the requested language and domain, the key phrase sampler and similarity analysis process ends, and the process proceeds to step 935. At step 935, the entity sampler is initiated based on the secondary seed and the entity types that were generated and randomly selected at steps 910 and 912.

At step 937, unless the required number of entities have been generated, the entity sampler and generation process continue at step 940. However, when the required number of entities have been generated, the entity sampler and generation process proceed to step 945. A determination of whether the required number of entities have or have not been generated may be based on a predetermined threshold number (e.g., based on a length of text scripts a user needs for training the downstream model, similar to the required number of keyphrases as discussed in further detail herein) of entities to be generated and collected for the training purposes of the LLM. The predetermined threshold number of entities may be configurable in the application and thus the determination may be made based on a user defined configuration.

At step 940, a corresponding entity provider (subsystem or module) is called for each of the one or more identified different forms of entities and the corresponding entity provider(s) generate the entities and their normalized forms via a series of rules and algorithms based on the entity type and target language.

At step 945, the Text Script Generator subsystem (e.g., the Text Script Generator subsystem 225 described with respect to FIG. 2) generates domain specific text scripts by combining the keyphrases (generated in keyphrase sampler block) with the entities (generated in entity sampler block) using one or more LLMs. At step 947, the entities may be replaced in the text scripts with their normalized forms to generate a normalized form of the text scripts.

At step 950, a smaller Language Model such as a multilingual text to text generation model (e.g., mT5) may be used to identify and generate normalized text scripts based on newly identified entities generated by the one or more LLMs.

At step 955, the normalized text scripts are post-processed by removing speaker names, removing enclosed entity types, removing “mailto” text, removing entity duplication, removing trailing quotes, or any combination thereof. At step 960, the normalized text scripts may be further post-processed by removing brackets, removing symbols, separating mid token capitalization, replacing acronyms, changing numbers to words, changing salutations, or any combination thereof. At step 965, one or more integrity checks may be performed to check whether colon(s) exist in the text scripts and/or normalized text scripts, check whether text scripts and/or normalized text scripts exceed a maximum character, word, or token threshold, check whether all entities are present in the exist in the text scripts and/or normalized text scripts. At step 970, a determination is made as to whether the text scripts and/or normalized text scripts are valid based on the integrity checks (e.g., if colons present and/or the text scripts and/or normalized text scripts exceed a maximum character, word, or token threshold the determination may be made the text scripts and/or normalized text scripts are invalid). If the text scripts and/or normalized text scripts are valid, the datapoint counter is increased by one at step 975 and the process returns to step 907 for further processing. If the text scripts and/or normalized text scripts are invalid, the process returns to step 915 for further processing.

### Speech Audio Generator

Once the text and its normalized forms are generated, the normalized text scripts are fed to the Speech Audio Generation Module (e.g., audio generation pipeline 210 as described with respect to FIG. 2). The audio generation module takes in the input text, a prompt comprised of speech style and a reference audio, and generates audio styled as per the style prompt, and voice cloned as per the reference audio. The speech generation module utilizes the following two models for speech audio generation: a TTS model capable of injecting particular style into the audio such as Parler TTS and a tone color convertor capable of Cross Lingual Voice Cloning through Language Agnostic Tone Color Cloner such as the cloner provided by Open VoiceV2.

The TTS Model generates audio by optionally processing the input text (normalized text scripts) to normalize them further in accordance with the particular TTS model being used. This step involves converting text into a form that the model can understand, such as breaking it into phonemes (the smallest units of sound) or other linguistic representations. The acoustic model then predicts the features of the audio, such as pitch, intonation, and timing, based on the input text. Neural networks like Tacotron 2 or Transformer-based models may be used in this step. It is at this step that the particular style desired may be injected into the audio. The vocoder then converts the acoustic features into actual audio waveforms. Typical vocoders include WaveNet, WaveGlow, and HiFi-GAN, which generate natural-sounding speech from the predicted features. Finally, the speech generation module may refine the audio output to improve clarity and reduce noise. The acoustic model should be capable of styling the output to specific characters such as News Anchor, A storyteller, etc. using text-based prompts. For example, a LLM may be used to generate styling prompts for several such characters and store them in the Speech Audio Generation Module or application. Whenever a request arrives from a user or the framework to generate a styled text, the user or the framework has an option to either choose a character and the corresponding style prompt from a list of prompts, or not choose an existing character, and provide a styling prompt themselves or itself. The generated audio from the TTS model corresponds to the final style prompt chosen by the user or the framework. Following in Table 7 are some of the character specific sample prompts that can be used to generate voice samples using the TTS model:

TABLE 7

| Speaker | |
|---|---|
| Character | Styling Prompt |
| Newsreader | A professional male voice with a neutral accent delivers news in a clear, |
| | authoritative tone at a moderate pace. |
| | A female newsreader with a slightly high-pitched voice speaks articulately with |
| | crisp enunciation and subtle emphasis on key points. |
| | An experienced anchor with a deep, resonant voice presents news in a serious |
| | manner with occasional subtle inflections for emphasis. |
| Storyteller | A gentle, soothing female voice with a slight lilt narrates a bedtime story, speaking |
| | softly and slowly with a dreamy quality. |
| | A charismatic male storyteller with a rich, expressive voice dramatically narrates |
| | an adventure tale, using varied pacing and tonal shifts. |
| | An elderly narrator with a slightly gravelly voice recounts a historical event, |
| | speaking deliberately with occasional pauses for reflection. |

The tone color convertor takes in a reference audio from the user, and the source audio from the TTS model, and then generates a speech audio styled exactly as before, while sounding like the reference audio. Cross-lingual Voice Cloning using a Language-Agnostic Tone Color Cloner (LATCC) is a model process that enables the voice cloning of the reference audio (i.e., reference speaker's voice) in a language and/or text script they may have never spoken before. The core idea is to separate the unique characteristics of a speaker's voice—such as tone, pitch, timbre, and speaking style (collectively referred to as “tone color”)—from the linguistic and phonetic elements of speech, making the system language-agnostic-meaning that the process can use audio from any language as reference audio, and the tone color converter will be able to extract acoustic tone features from the reference audio and clone the tone on the source audio. This helps scale training data generation and voice standardization, without the need for voice artists which know a specific language, thus allowing for cross-lingual voice cloning. This begins with a speaker encoder that extracts a compact numerical representation, or “embedding,” of the speaker's voice. The embedding captures the speaker's vocal identity in a way that is independent of any specific language. The language-agnostic nature of this process is achieved by training the encoder on multilingual datasets and employing techniques like self-supervised learning, enabling it to generalize across languages without being tied to a single linguistic framework.

Once the speaker's unique voice features are encoded, the system processes the linguistic content of the target language and/or text script through a text-to-phoneme conversion and prosody modeling pipeline. This involves analyzing the structure, phonemes, and intonation patterns of the target language and/or text script to generate natural-sounding speech. A tone color cloner then combines the speaker embedding with the linguistic features of the target language and/or text script to synthesize acoustic representations (e.g., mel-spectrograms) that match the speaker's voice characteristics while adhering to the phonetic and prosodic rules of the target language and/or text script. This ensures that the cloned voice not only retains the original speaker's identity but also sounds fluent and natural in the target language and/or text script. As discussed above, neural models like Tacotron 2 or transformer-based architectures may be used for this purpose, with vocoders (e.g., HiFi-GAN or WaveNet) converting the acoustic features into high-quality audio waveforms.

### AI Platform

FIG. 10 shows a block diagram of a machine learning pipeline 1000 comprising several subsystems that work together to train, validate, and implement one or more machine learning models in accordance with various embodiments. The machine learning pipeline 1000 may be executed as part of the pipeline framework 200 described in FIG. 2 (e.g., training and validation pipeline 250) to train or fine-tune one or more machine learning models (e.g., LLMs) with training data-both textual and the corresponding speech synthetically generated as described herein.

The machine learning pipeline 1000 comprises a data subsystem 1005 for collecting, generating, preprocessing, and labeling of training and validation datasets 1010, training and validation subsystem 1015 that facilitates the training and validation of one or more machine learning algorithms 1020 or one or more pre-trained machine learning models 1023, and inference subsystem 1025 for deploying and implementing one or more trained machine learning models 1030 independently or in combination with one or more other systems or services 1035 for downstream processes.

As used herein, machine learning algorithms (also described herein as simply algorithm or algorithms) are procedures that are run on datasets (e.g., training and validation datasets) and perform pattern recognition on datasets, learn from the datasets, and/or are fit on the datasets. Examples of machine learning algorithms include linear and logistic regression, decision trees, artificial neural networks, k-means, transformer architectures with attention mechanisms, and k-nearest neighbor. In contrast, machine learning models (also described herein as simply model or models) are the output of the machine learning algorithms and are comprised of model data and a prediction algorithm. In other words, the machine learning model is the program that is saved after running a machine learning algorithm on training data and represents the rules, numbers, and any other algorithm-specific data structures required to make inferences. For example, a linear regression algorithm may result in a model comprised of a vector of coefficients with specific values, and a transformer architecture with attention mechanisms may result in a LLM that utilizes self-attention mechanisms, allowing the model to weigh the importance of different words in a sentence when making predictions.

In the specific context of this disclosure, the machine learning model(s) may be TTS and/or SST models. Machine learning models for TTS systems are designed to convert written text into natural-sounding spoken words. Conventional TTS systems relied on concatenative synthesis, which used pre-recorded speech segments stitched together to form words and sentences. However, more recent TTS systems leverage neural network-based approaches for greater flexibility and naturalness. One type is sequence-to-sequence models, such as Tacotron and Tacotron 2, which directly map input text to a spectrogram (a visual representation of sound frequencies) and then use a vocoder like WaveNet or HiFi-GAN to synthesize audio from the spectrogram. Tacotron models utilize attention mechanisms to align text and speech outputs, enabling them to handle variable-length inputs and produce smooth, natural prosody. Additionally, end-to-end models like FastSpeech and FastSpeech 2 can improve efficiency by removing the need for intermediate alignment steps, making them faster and more scalable while maintaining high-quality speech synthesis.

Another type of model used in TTS is the transformer-based architecture, which employs self-attention mechanisms to model long-range dependencies in both text and audio sequences. These models, such as VITS (Variational Inference Text-to-Speech), combine variational autoencoders and adversarial training to generate highly realistic and expressive speech. Neural TTS systems can also incorporate style transfer techniques, allowing them to mimic different accents, emotions, or speaking styles by conditioning the model on speaker embeddings or prosody features. Overall, neural-based TTS models have revolutionized the field by producing speech that closely resembles human voices, with implementation ranging from voice assistants to audiobook narration.

SST, also known as Automatic Speech Recognition (ASR), involves converting spoken words into written text. Traditional ASR systems employed a pipeline approach comprised of acoustic models, language models, and feature extraction techniques like Mel-Frequency Cepstral Coefficients (MFCCs). Modern SST systems, however, leverage end-to-end deep learning models for simplicity and improved accuracy. Recurrent Neural Networks (RNNs), such as Long Short-Term Memory (LSTM) and Gated Recurrent Units (GRUs), may be implemented for SST tasks due to their ability to handle sequential data. These models map audio features to text outputs by learning temporal dependencies. In some instances, transformer-based architectures like wav2vec 2.0, Whisper, and Conformer may be implemented, as they combine self-attention mechanisms with convolutional layers to efficiently model both short- and long-term dependencies in audio signals.

End-to-end SST models such as Deep Speech and wav2vec 2.0 process raw audio waveforms or spectrograms directly, eliminating the need for handcrafted feature extraction. These models may use a Connectionist Temporal Classification (CTC) loss function or sequence-to-sequence training with attention mechanisms to align audio inputs with text outputs. Transformer-based models have further improved SST performance by leveraging pretraining on large-scale unlabeled audio datasets, followed by fine-tuning on labeled data. This approach can allow them to generalize well to different accents, dialects, and noisy environments. SST systems may be implemented in transcription services, voice-controlled interfaces, and accessibility tools, providing fast and accurate speech recognition across diverse applications.

### Data Subsystem

Data subsystem 1005 is used to collect, generate, preprocess, and label data to be used to train and validate one or more machine learning algorithms 1020 or one or more pre-trained machine learning models 1023. The data collection can include exploring various data sources such as public datasets, private data collections, or real-time data streams, depending on a project's needs. In some instances, a data source is a public or online repository of information or examples pertinent to a general or target domain space (e.g., financial or medical text scripts). Many domains have publicly available datasets provided by governments, universities, or organizations. For example, many government and private entities offer datasets on healthcare, environmental data, and more through various portals. For proprietary needs, data might be available through partnerships or purchases from private companies that specialize in data aggregation. In other instances, a data source is a private repository of information or examples pertinent to a general or target domain space. For example, a data source can be the storage device that stores digital text scripts and associate audio accessed by the pipeline framework 200 described in FIG. 2. Once a data source is identified, data subsystem 1005 can be used to collect data through appropriate methods such as downloading from online repositories, web scraping, using APIs for real-time data, creating datasets through surveys and requests for access, or by running programs or scripts. The acquired raw data may be further preprocessed to generate the training and validation datasets 1010.

In some instances, raw data (e.g., text scripts and associated audio) may be generated as opposed to being collected or acquired. Data generating may comprise data synthesis and/or data augmentation. Different data synthesis and/or data augmentation techniques may be implemented by the data subsystem 1005 to generate data to be used for the training and validation subsystem 1015. Data synthesizing involves creating entirely new data points from scratch, as discussed in detail herein with respect to FIGS. 2-9. Data synthesis may be used when real data is insufficient, too sensitive to use, or when the cost and logistical barriers to obtaining more real data are too high. The synthesized data should be realistic enough to effectively train a machine learning model, but distinct enough to comply with regulations (e.g., copyright and data privacy), if necessary. Data augmentation, on the other hand, refers to techniques used to artificially expand the size of a dataset by creating modified versions of existing data examples. The primary goal of data augmentation is to increase variation in the data in order to make the model more robust to variations it might encounter in the real world, thereby improving its ability to generalize from the training data to unseen data. This is especially common in image and speech recognition tasks but is applicable to other data types as well. For images, data augmentation may include rotations, flipping, scaling, or altering the lighting conditions. For text, data augmentation may include synonyms replacement, back translation, or sentence shuffling. For audio, data augmentation may include changes made to pitch, speed, or background noise.

Preprocessing may be implemented by the data subsystem 1005, serving as a bridge between raw data acquisition and effective model training. The primary objective of preprocessing is to transform the raw data into a format that is more suitable and efficient for analysis, ensuring that the data fed into machine learning algorithms or pretrained models is clean, consistent, and relevant. This step can be useful because raw data often comes with a variety of issues such as missing values, noise, irrelevant information, and inconsistencies that can significantly hinder the performance of a model. By standardizing and cleaning the data beforehand, preprocessing helps in enhancing the accuracy and efficiency of the subsequent analysis, making the data more representative of the underlying problem the model aims to solve.

Other raw data preprocessing techniques that may be utilized include data cleaning, normalization, feature extraction, dimensionality reduction, and the like. Data cleaning may involve removing duplicates, filling in missing values, or filtering out outliers to improve data quality. Normalization involves scaling numeric values to a common scale without distorting differences in the ranges of values, which helps prevent biases in the model due to the inherent scale of features. Feature extraction involves transforming the input data into a set of useable features, possibly reducing the dimensionality of the data in the process. For instance, in audio analysis, feature reduction techniques such as Principal Component Analysis (PCA), Linear Discriminant Analysis (LDA), t-Distributed Stochastic Neighbor Embedding (t-SNE), Non-Negative Matrix Factorization (NMF), and feature selection can be used for simplifying the representation of audio signals while retaining the most relevant information for tasks like classification, recognition, or synthesis. These techniques not only help in reducing the computational load on the model but also in mitigating issues like overfitting by simplifying the data without losing critical information.

In the instance that machine learning pipeline 1000 is used for supervised or semi-supervised learning of machine learning models, labeling techniques can be implemented as part of the data collection. The quality and accuracy of data labeling directly influence the model's performance, as labels serve as the definitive guide that the model uses to learn the relationships between the input features and the desired output. Particularly in complex domains such as image analysis, natural language processing, or medical diagnosis, precise and consistent labeling is important because it provides the ground truth or target outcomes against which the model's predictions are compared and adjusted during training. Effective labeling ensures that the model is trained on correct and clear examples, thus enhancing its ability to generalize from the training data to real-world scenarios. In some instances, the annotation labels and ground truth values (labels) are appended or annotated within the raw data. For example, when the raw data includes text scripts, the labels may include the one or more spans and corresponding named entities.

Labeling techniques can vary significantly depending on the type of data and the specific requirements of the project. Manual labeling, where human annotators label the data, is one method that can be used. This approach may be useful when a detailed understanding and judgment are required, such as in labeling medical text or categorizing text data where context and subtlety are important. However, manual labeling can be time-consuming and prone to inconsistency, especially with a large number of annotators. To mitigate this, semi-automated labeling tools may be used as part of data subsystem 1005 to pre-label data using algorithms, which human annotators may then review and correct as needed. Another approach is active learning, a technique where the model being developed is used to label new data iteratively. The model suggests labels for new data points, and human annotators may review and adjust certain predictions such as the most uncertain predictions. This technique optimizes the labeling effort by focusing human resources on a subset of the data, e.g., the most ambiguous cases, improving efficiency and label quality through continuous refinement.

Once collected, generated, preprocessed, and/or labeled, the data may then be split into the training and validation datasets 1010. The training and validation datasets 1010 may comprise the raw data and/or the preprocessed data. The training and validation datasets 1010 are typically split into at least three subsets of data: training, validation, and testing. The training set is used to fit the model, where the machine learning model learns to make inferences based on the training data. The validation set, on the other hand, is utilized to tune hyperparameters and prevent overfitting by providing a sandbox for model selection. Finally, the test set serves as a new and unseen dataset for the model, used to simulate real-world application and evaluate the final model's performance. The process of splitting ensures that the model can perform well not just on the data it was trained on, but also on new, unseen data, thereby validating and testing its ability to generalize.

Various techniques can be employed to split the data effectively, with each method aiming to maintain a good representation of the overall dataset in each subset. A simple random split (e.g., a 70/20/10%, 80/10/10%, or 60/25/15%) is the most straightforward approach, where examples from the data are randomly assigned to each of the three sets. In some instances, the splitting is performed such that 70% of the training and validation datasets 1010 are for training, 10% are for validation, and 20% are for testing. However, more sophisticated methods may be necessary to preserve the underlying distribution of data. For instance, stratified sampling may be used to ensure that each split reflects the overall distribution of a specific variable, particularly useful in cases where certain categories or outcomes are underrepresented. Another technique, k-fold cross-validation, involves rotating the validation set across different subsets of the data, maximizing the use of available data for training while still holding out portions for validation. These methods help in achieving more robust and reliable model evaluation and are useful in the development of predictive models that perform consistently across varied datasets.

Data subsystem 1005 is also used for collecting, generating, setting, or implementing model hyperparameters 1040 for the training and validation subsystem 1015. The hyperparameters control the overall behavior of the models. Unlike model parameters 1045 that are learned automatically during training, hyperparameters 1040 are set before training begins and have a significant impact on the performance of the model. For example, in a neural network such as that of an LLM, hyperparameters include the learning rate, number of layers, number of neurons/nodes per layer, activation functions, convolution kernel width, the number of kernels for a model, among others. These settings can determine how quickly a model learns, its capacity to generalize from training data to unseen data, and its overall complexity. Correctly setting hyperparameters is important because inappropriate values can lead to models that underfit or overfit the data. Underfitting occurs when a model is too simple to learn the underlying pattern of the data, and overfitting happens when a model is too complex, learning the noise in the training data as if it were signal.

### Training, Validation, and Testing

The training and validation subsystem 1015 is comprised of a combination of specialized hardware and software to efficiently handle the computational demands required for training, validating, and testing a machine learning model. On the hardware side, high-performance GPUs (Graphics Processing Units) may be used for their ability to perform parallel processing, drastically speeding up the training of complex models, especially deep learning networks. CPUs (Central Processing Units), while generally slower for this task, may also be used for less complex model training or when parallel processing is less critical. TPUs (Tensor Processing Units), designed specifically for tensor calculations, provide another level of optimization for machine learning tasks. On the software side, a variety of frameworks and libraries are utilized, including TensorFlow, PyTorch, Keras, and scikit-learn. These tools offer comprehensive libraries and functions that facilitate the design, training, validation, and testing of a wide range of machine learning models across different computing platforms, whether local machines, cloud-based systems, or hybrid setups, enabling developers to focus more on model architecture and less on underlying computational details.

Training is the initial phase of developing machine learning models 1030 where the model learns to make predictions or decisions based on data training data provided from the training and validation datasets 1010. During this phase, the model iteratively adjusts its internal model parameters 1045 to achieve a preset optimization condition. In a supervised machine learning training process, the preset optimization condition can be achieved by minimizing the difference between the model output (e.g., predictions, classifications, or decisions) and the ground truth labels in the training data. In some instances, the preset optimization condition can be achieved when the preset fixed number of iterations or epochs (full passes through the training dataset) is reached. In some instances, the preset optimization condition is achieved when the performance on the validation dataset stops improving or starts to degrade. In some instances, the preset optimization condition is achieved when a convergence criterion is met, such as when the change in the model parameters falls below a certain threshold between iterations. This process, known as fitting, is fundamental because it directly influences the accuracy and effectiveness of the model.

In an exemplary training phase performed by the training and validation subsystem 1015, the training subset of data is input into the machine learning algorithms 1020 or pre-trained models 1023 to find a set of model parameters 1045 (e.g., weights, coefficients, trees, feature importance, and/or biases) that minimizes or maximizes an objective function (e.g., a loss function, a cost function, a contrastive loss function, a cross-entropy loss function, an Out-of-Bag (OOB) score, etc.). To train the machine learning algorithms 1020 or pre-trained models 1023 to achieve accurate predictions, “errors” (e.g., a difference between a predicted label and the ground truth label) need to be minimized. In order to minimize the errors, the model parameters can be configured to be incrementally updated by minimizing the objective function over the training phase (“optimization”). Various different techniques may be used to perform the optimization. For example, to train machine learning algorithms or pre-trained models such as a neural network, optimization can be done using back propagation. The current error is typically propagated backwards to a previous layer, where it is used to modify the weights and bias in such a way that the error is minimized. The weights are modified using the optimization function. Other techniques such as random feedback, Direct Feedback Alignment (DFA), Indirect Feedback Alignment (IFA), Hebbian learning, and the like can also be used to update the model parameters 1045 in a manner as to minimize or maximize an objective function. This cycle is repeated until a desired state (e.g., a predetermined minimum value of the objective function) is reached.

The training phase is driven by three primary components: the model architecture (which defines the structure of the algorithm(s) 1020 or pretrained model(s) 1023), the training data (which provides the examples from which to learn), and the learning algorithm (which dictates how the model adjusts its model parameters). The goal is for the model to capture the underlying patterns of the data without memorizing specific examples, thus enabling it to perform well on new, unseen data.

The model architecture is the specific arrangement and structure of the various components and/or layers that make up a model. In the context of a neural network, the model architecture may include the configuration of layers in the neural network, such as the number of layers, the type of layers (e.g., convolutional, recurrent, fully connected), the number of neurons in each layer, and the connections between these layers. In the context of a LLM comprised of a transformer architecture, which utilizes self-attention mechanisms to process and generate human-like text. The transformer model comprises an encoder-decoder structure, where the encoder processes the input text, and the decoder generates the output. The self-attention mechanism allows the model to weigh the importance of different words in a sentence, capturing long-range dependencies and contextual relationships. This architecture enables the model to handle large-scale data and understand complex language patterns. During training, the optimization algorithm such as Adam is used to minimize the loss function through backpropagation, and regularization techniques like dropout are employed to prevent overfitting, resulting in a robust and efficient language model capable of performing various natural language processing tasks such as predicting the ADR relations.

The model architecture also encompasses the choice and arrangement of features and algorithms used in various models, such as neural networks and transformers. The architecture determines how input data is processed and transformed through various computational steps to produce the output. The model architecture directly influences the model's ability to learn from the data effectively and efficiently, and it impacts how well the model performs tasks such as classification, regression, or prediction, adapting to the specific complexities and nuances of the data it is designed to handle.

The learning algorithm is the overall method or procedure used to adjust the model parameters 1045 to fit the data. It dictates how the model learns from the data provided during training. This includes the steps or rules that the algorithm follows to process input data and make adjustments to the model's internal parameters (e.g., weights in neural networks) based on the output of the objective function. Examples of learning algorithms include gradient descent, backpropagation for neural networks, and splitting criteria in decision trees.

Various techniques may be employed by training and validation subsystem 1015 to train machine learning models 1030 using the learning algorithm, depending on the type of model and the specific task. For supervised learning models, where the training data includes both inputs and expected outputs (e.g., ground truth labels), gradient descent is a possible method. This technique iteratively adjusts the model parameters 1045 to minimize or maximize an objective function (e.g., a loss function, a cost function, a contrastive loss function, etc.). The objective function is a method to measure how well the model's predictions match the actual labels or outcomes in the training data. It quantifies the error between predicted values and true values and presents this error as a single real number. The goal of training is to minimize this error, indicating that the model's predictions are, on average, close to the true data. Common examples of loss functions include mean squared error for regression tasks and cross-entropy loss for classification tasks.

The adjustment of the model parameters 1045 is performed by the optimization function or algorithm, which refers to the specific method used to minimize (or maximize) the objective function. The optimization function is the engine behind the learning algorithm, guiding how the model parameters 1045 are adjusted during training. It determines the strategy to use when searching for the best weights that minimize (or maximize) the objective function. Gradient descent is a primary example of an optimization algorithm, including its variants like stochastic gradient descent (SGD), mini-batch gradient descent, and advanced versions like Adam or RMSprop, which provide different ways to adjust learning rates or take advantage of the momentum of changes. For example, in training a neural network, backpropagation may be used with gradient descent to update the weights of the network based on the error rate obtained in the previous epoch (cycle through the full training dataset). Another technique in supervised learning is the use of decision trees, where a tree-like model of decisions is built by splitting the training dataset into subsets based on an attribute value test. This process is repeated on each derived subset in a recursive manner called recursive partitioning.

In unsupervised learning, where training data does not include labels, different techniques are used. Clustering is one method where data is grouped into clusters that maximize the similarities of data within the same cluster and maximize the differences with data in other clusters. The K-Means algorithm, for example, assigns each data point to the nearest cluster by minimizing the sum of distances between data points and their respective cluster centroids. Another technique, Principal Component Analysis (PCA), involves reducing the dimensionality of data by transforming it into a new set of variables, the principal components, which are uncorrelated and ordered so that the first few retain most of the variation present in all of the original variables. These techniques help uncover hidden structures or patterns in the data, which can be essential for feature reduction, anomaly detection, or preparing data for further supervised learning tasks.

Validating is another phase of developing machine learning models 1030 where the model is checked for deficiencies in performance and the hyperparameters 1040 are optimized based on validation data provided from the training and validation datasets 1010. The validation data helps to evaluate the model's performance, such as accuracy, precision, recall, or F1-score, to gauge how well the model is likely to perform in real-world scenarios. Hyperparameter optimization, on the other hand, involves adjusting the settings that govern the model's learning process (e.g., learning rate, number of layers, size of the layers in neural networks) to find the combination that yields the best performance on the validation data. One optimization technique is grid search, where a set of predefined hyperparameter values are systematically evaluated. The model is trained with each combination of these values, and the combination that produces the best performance on the validation set is chosen. Although thorough, grid search can be computationally expensive and impractical when the hyperparameter space is large. A more efficient alternative optimization technique is random search, which samples hyperparameter combinations from a defined distribution randomly. This approach can in some instances find a good combination of hyperparameter values faster than grid search. Advanced methods like Bayesian optimization, genetic algorithms, and gradient-based optimization may also be used to find optimal hyperparameters more effectively. These techniques model the hyperparameter space and use statistical methods to intelligently explore the space, seeking hyperparameters that yield improvements in model performance.

An exemplary validation process includes iterative operations of inputting the validation subset of data into the trained algorithm(s) using a validation technique such as K-Fold Cross-Validation, Leave-one-out Cross-Validation, Leave-one-group-out Cross-Validation, Nested Cross-Validation, or the like, to fine-tune the hyperparameters and ultimately find the optimal set of hyperparameters. In some instances, a 5-fold cross-validation technique may be used to avoid overfitting the trained algorithm and/or to limit the number of selected features per split to the square-root of the total number of input features. In some instances, training dataset is split into 5 equal-size cohorts (or about equal-size), and every four of the cohorts are used to train an algorithm to generate five models (e.g, cohorts #1, 2, 3, and 4 are used to train and generate model 1, cohorts #1, 2, 3, and 5 are used to train and generate model 2, cohorts #1, 2, 4, and 5 are used to train and generate model 3, cohorts #1, 3, 4, and 5 are used to train and generate model 4, and cohorts #2, 3, 4 and 5 are used to train and generate model 5). Each model is evaluated (or validated) using the unused cohort in the training (e.g., for model 5, cohort #1 is used for validation). The overall performance of the training can be evaluated by an average performance of the five models. K-fold cross-validation provides a more robust estimate of a model's performance compared to a single training/validation split because it utilizes the entire dataset for both training and evaluation and reduces the variance in the performance estimate.

Once a machine learning model has been trained and validated, it undergoes a final evaluation using test data provided from the training and validation datasets 1010, which is a separate subset of the data that has not been used during the training or validation phases. This step is crucial as it provides an unbiased assessment of the model's performance in simulating real-world operation. The test dataset serves as new, unseen data for the model, mimicking how the model would perform when deployed in actual use. During testing, the model's predictions are compared against the true values in the test dataset using various performance metrics such as accuracy, precision, recall, and mean squared error, depending on the nature of the problem (classification or regression). This process helps to verify the generalizability of the model—its ability to perform well across different data samples and environments—highlighting potential issues like overfitting or underfitting and ensuring that the model is robust and reliable for practical applications. The machine learning models 1030 are fully validated and tested once the output predictions have been deemed acceptable by user defined acceptance parameters. Acceptance parameters may be determined using correlation techniques such as Bland-Altman method and the Spearman's rank correlation coefficients and calculating performance metrics such as the error, accuracy, precision, recall, receiver operating characteristic curve (ROC), etc.

### Inference Phase for Machine Learning Models

The inference subsystem 1025 is comprised of various components for deploying the machine learning models 1030 in a production environment (e.g., use as cloud service as described with respect to FIGS. 13-17). Deploying the machine learning models 1030 includes moving the models from a development environment (e.g., the training and validation subsystem 1015, where it has been trained, validated, and tested), into a production environment where it can make inferences on real-world data (e.g., input data 1050). This step typically starts with the model being saved after training, including its parameters and configuration such as final architecture and hyperparameters. It is then converted, if necessary, into a format that is suitable for deployment, depending on the deployment environment. For instance, a model trained in a scientific computing environment such as Python might be converted into a Java-friendly format for integration into a larger enterprise application.

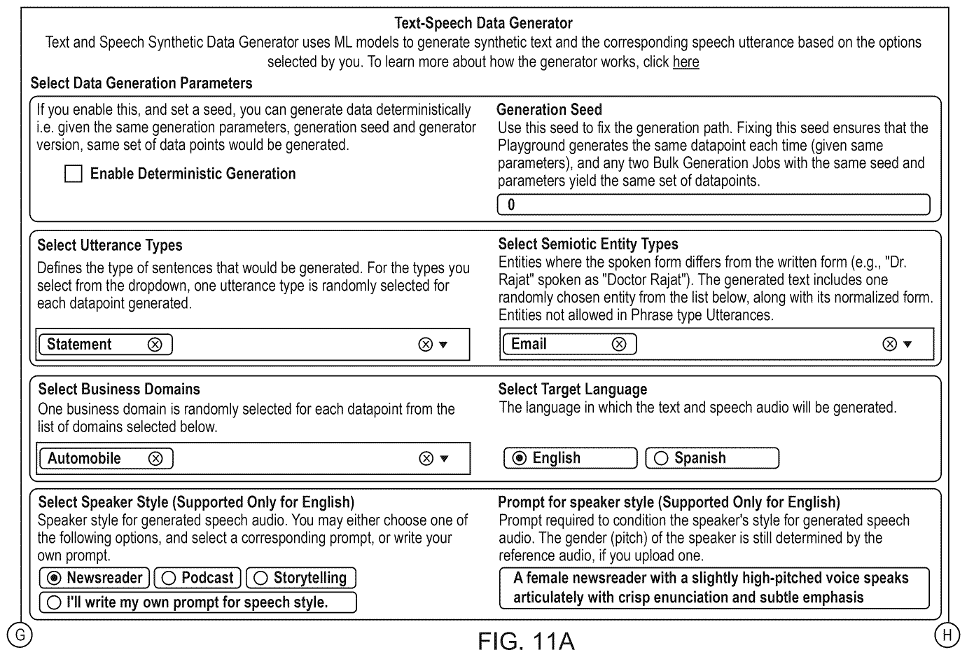

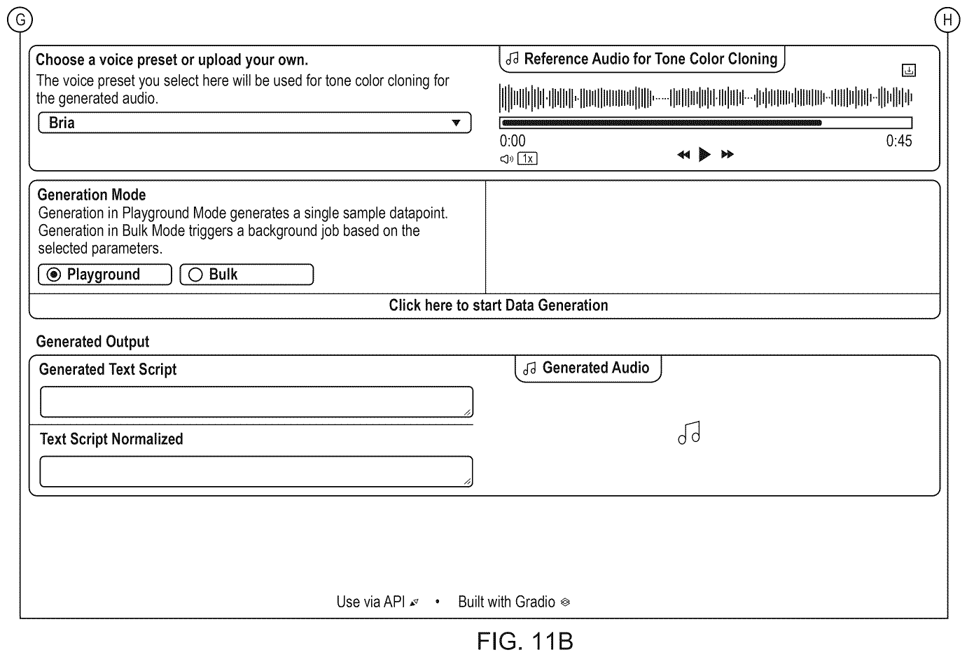

Deployment can be conducted on various platforms, including on-premises servers or cloud environments like Oracle's Cloud Infrastructure (OCI), as described in greater detail with respect to FIGS. 13-17. In some instances, a portion of or the entire framework 200 described with respect to FIG. 2 can be bundled into an application (see FIGS. 11A-11B, which shows a screenshot of an exemplary app) such as a Gradio application executable on one or more of the various platforms. A Gradio application is an open-source Python package that allows a user to quickly build a demo or web application for their machine learning model, API, or any arbitrary Python function (e.g., a could service application). The application can be built to enable users to play around with the training data generator in a playground mode, as well as generate training dataset in bulk and train models using the training dataset.

Once deployed, the model is ready to receive input data 1050 and return outputs (e.g., inferences 1055). In some instances, the model resides as a component of a larger system or service (e.g., including additional downstream applications 1035). In some instances, the models 1030 and/or the inferences 1055 can be used by the downstream applications 1035 to provide further information. For example, the inferences 1055 can be used to for converting text to audio, detecting audio, converting audio to text, and the like. The downstream applications can be configured to generate an output 1060. In some instances, the output 1060 comprises a report including inferences 1055 and information generated by the downstream applications 1035.

To manage and maintain its performance, a deployed model may be continuously monitored to ensure it performs as expected over time. This involves tracking the model's prediction accuracy, response times, and other operational metrics. Additionally, the model may require retraining or updates based on new data or changing conditions in the environment it is applied in. This can be useful because machine learning models can drift over time due to changes in the underlying data they are making predictions on—a phenomenon known as model drift. Therefore, maintaining a machine learning model in a production environment often involves setting up mechanisms for performance monitoring, regular evaluations against new test data, and potentially periodic updates and retraining of the model to ensure it remains effective and accurate in making predictions.

### Techniques for Synthesizing Text Scripts and Associated Audio for Training Models

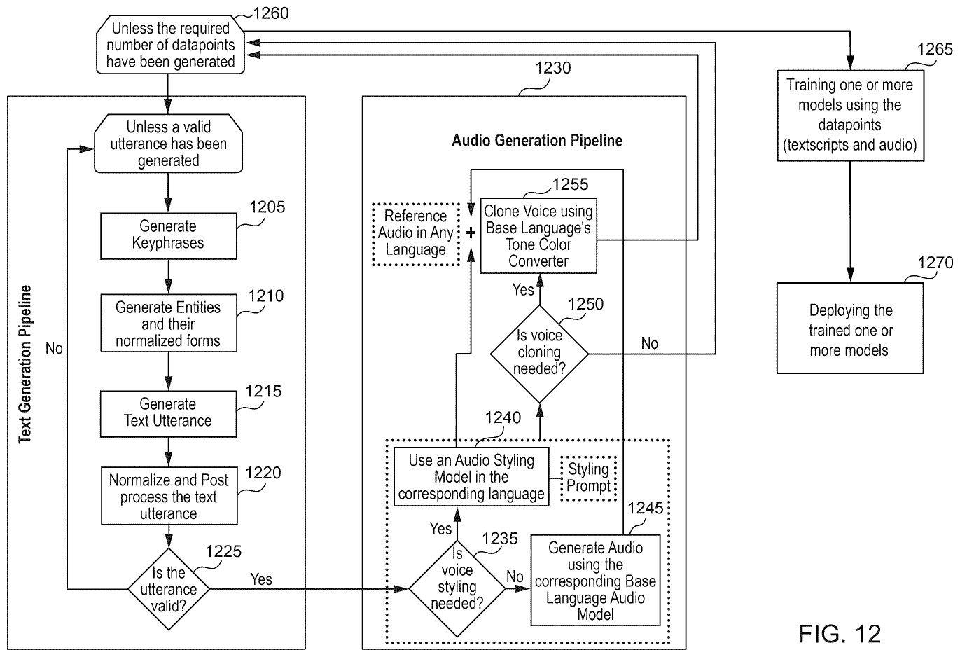

FIG. 12 depicts a simplified flowchart 1200 illustrating a process for synthesizing text scripts and associated audio for training models according to certain embodiments. The processing depicted in FIG. 12 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 12 and described below is intended to be illustrative and non-limiting. Although FIG. 12 depicts the various processing steps occurring in a particular sequence or order, this is not intended to be limiting. In certain alternative embodiments, the steps may be performed in some different order, or some steps may also be performed in parallel.

The process commences in step 1205, keyphrases are generated by a first generative artificial intelligence model for a domain. In some instances, generating the key phrases is an iterative process that comprises determining whether a required number of keyphrases are available in a keyphrase store based on a current number or size of keyphrases stored in the keyphrase store and a predetermined threshold number of keyphrases to be generated and collected; when the required number of keyphrases are unavailable in the keyphrase store, generating, by the first generative artificial intelligence model, a keyphrase for the domain using multistep conversational prompting; evaluating a similarity of the keyphrase with each of the keyphrases stored in the keyphrase store; when the keyphrase is not similar to the keyphrases stored in the keyphrase store based on the evaluating, storing the keyphrase in the keyphrase store; and when the keyphrase is similar to at least one of the keyphrases stored in the keyphrase store based on the evaluating, skipping the keyphrase and proceeding back to generating, by the first generative artificial intelligence model, a keyphrase for the domain using the multistep conversational prompting.

At step 1210, entities and associated normalized forms are generated. In some instances, generating the entities and the associated normalized forms is an iterative process that comprises: determining whether a required number of entities have been generated based on an entity counter and a predetermined threshold number of entities to be generated and collected; when the required number of entities have not been generated, sampling an entity from a list of possible entities; identifying a type of semiotic entity required for the sampled entity; executing an entity provider associated with the type of semiotic entity required for the sampled entity, wherein the executing comprises generating a semiotic entity and a corresponding normalized form of the semiotic entity deterministically using a set of rules and one or more algorithms; and increasing the entity counter by one.

At step 1215, text scripts are generated, by a second generative artificial intelligence model, for the domain based on the keyphrases and the entities and their associated normalized forms. In some instances, the text scripts are generated by combining one or more of the keyphrases with one or more of the entities and forcing the second generative artificial intelligence model to generate the text scripts in a predefined type and format using a custom prompt for the predefined type and a library enforcer for the predefined format. In some instances, at step 1220, the process further comprises replacing the entities in the text scripts with the normalized forms associated with each of the entities; and normalizing, by a language model, any new entities within the text scripts that were generated by the second generative artificial intelligence model during the process of generating the text scripts.

At step 1225, prior to generating audio associated with each of the text scripts, a validity of each of the text scripts is determined based on integrity checks. When a text script is invalid based on the validity determination, the text script is removed from the process; and when the text script is valid based on the validity determination, the text script is kept in the method and the audio associated with text script is generated.

At step 1230, audio associated with each of the text scripts are generated by one or more audio models. In some instances, generating the audio associated with each of the text scripts comprises: determining at step 1235 whether voice styling is needed based on defined configurations; when voice styling is needed, generating at step 1240, by an audio styling model of the one or more audio models, the audio associated with each of the text scripts in the defined style and language; when voice styling is not needed, generating at step 1245, by a base language audio model of the one or more audio models, the audio associated with each of the text scripts; determining at step 1250 whether voice cloning is needed based on defined configurations; when voice cloning is needed, cloning at step 1255, by a cloning model of the one or more audio models and using a reference audio, a voice and modifying the audio associated with each of the text scripts in the defined style and language based on the cloned voice, and proceeding to perform step 1260 using the text scripts and the audio with the cloned voice and with or without voice styling associated with each of the text scripts; and when voice cloning is not needed, proceeding to perform step 1260 using the text scripts and the audio with or without voice styling associated with each of the text scripts.

At step 1260, a determination is made as to whether a required number of the text scripts and the audio associated with each of the text scripts have been generated and collected for training the one or more machine learning models based on a datapoint counter and a predetermined threshold number of datapoints. When the required number of the text scripts and the audio associated with each of the text scripts have not been generated, generating additional text scripts and audio associated with each of the additional text scripts by executing steps 1205-1255 for the same domain or a different domain and increasing the datapoint counter by one for each additional text script and associated audio that is generated; and when the required number of the text scripts and the audio associated with each of the text scripts have been generated, training, using the text scripts and the audio associated with each of the text scripts, the one or more machine learning models.

At step 1265, one or more machine learning models are trained using the text scripts and the audio associated with each of the text scripts. At step 1270, the one or more models may be deployed on a platform and used via an application and/or system.

### Illustrative Systems

The pipeline framework and techniques described herein can be offered as a cloud computing service. For example, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 13 is a block diagram 1300 illustrating an example pattern of an IaaS architecture, according to at least one embodiment. Service operators 1302 can be communicatively coupled to a secure host tenancy 1304 that can include a virtual cloud network (VCN) 1306 and a secure host subnet 1308. In some examples, the service operators 1302 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 1306 and/or the Internet.

The VCN 1306 can include a local peering gateway (LPG) 1310 that can be communicatively coupled to a secure shell (SSH) VCN 1312 via an LPG 1310 contained in the SSH VCN 1312. The SSH VCN 1312 can include an SSH subnet 1314, and the SSH VCN 1312 can be communicatively coupled to a control plane VCN 1316 via the LPG 1310 contained in the control plane VCN 1316. Also, the SSH VCN 1312 can be communicatively coupled to a data plane VCN 1318 via an LPG 1310. The control plane VCN 1316 and the data plane VCN 1318 can be contained in a service tenancy 1319 that can be owned and/or operated by the IaaS provider.

The control plane VCN 1316 can include a control plane demilitarized zone (DMZ) tier 1320 that acts as a perimeter network (e.g., portions of a corporate network between the corporate intranet and external networks). The DMZ-based servers may have restricted responsibilities and help keep breaches contained. Additionally, the DMZ tier 1320 can include one or more load balancer (LB) subnet(s) 1322, a control plane app tier 1324 that can include app subnet(s) 1326, a control plane data tier 1328 that can include database (DB) subnet(s) 1330 (e.g., frontend DB subnet(s) and/or backend DB subnet(s)). The LB subnet(s) 1322 contained in the control plane DMZ tier 1320 can be communicatively coupled to the app subnet(s) 1326 contained in the control plane app tier 1324 and an Internet gateway 1334 that can be contained in the control plane VCN 1316, and the app subnet(s) 1326 can be communicatively coupled to the DB subnet(s) 1330 contained in the control plane data tier 1328 and a service gateway 1336 and a network address translation (NAT) gateway 1338. The control plane VCN 1316 can include the service gateway 1336 and the NAT gateway 1338.

The control plane VCN 1316 can include a data plane mirror app tier 1340 that can include app subnet(s) 1326. The app subnet(s) 1326 contained in the data plane mirror app tier 1340 can include a virtual network interface controller (VNIC) 1342 that can execute a compute instance 1344. The compute instance 1344 can communicatively couple the app subnet(s) 1326 of the data plane mirror app tier 1340 to app subnet(s) 1326 that can be contained in a data plane app tier 1346.

The data plane VCN 1318 can include the data plane app tier 1346, a data plane DMZ tier 1348, and a data plane data tier 1350. The data plane DMZ tier 1348 can include LB subnet(s) 1322 that can be communicatively coupled to the app subnet(s) 1326 of the data plane app tier 1346 and the Internet gateway 1334 of the data plane VCN 1318. The app subnet(s) 1326 can be communicatively coupled to the service gateway 1336 of the data plane VCN 1318 and the NAT gateway 1338 of the data plane VCN 1318. The data plane data tier 1350 can also include the DB subnet(s) 1330 that can be communicatively coupled to the app subnet(s) 1326 of the data plane app tier 1346.

The Internet gateway 1334 of the control plane VCN 1316 and of the data plane VCN 1318 can be communicatively coupled to a metadata management service 1352 that can be communicatively coupled to public Internet 1354. Public Internet 1354 can be communicatively coupled to the NAT gateway 1338 of the control plane VCN 1316 and of the data plane VCN 1318. The service gateway 1336 of the control plane VCN 1316 and of the data plane VCN 1318 can be communicatively coupled to cloud services 1356.

In some examples, the service gateway 1336 of the control plane VCN 1316 or of the data plane VCN 1318 can make application programming interface (API) calls to cloud services 1356 without going through public Internet 1354. The API calls to cloud services 1356 from the service gateway 1336 can be one-way: the service gateway 1336 can make API calls to cloud services 1356, and cloud services 1356 can send requested data to the service gateway 1336. But, cloud services 1356 may not initiate API calls to the service gateway 1336.

In some examples, the secure host tenancy 1304 can be directly connected to the service tenancy 1319, which may be otherwise isolated. The secure host subnet 1308 can communicate with the SSH subnet 1314 through an LPG 1310 that may enable two-way communication over an otherwise isolated system. Connecting the secure host subnet 1308 to the SSH subnet 1314 may give the secure host subnet 1308 access to other entities within the service tenancy 1319.

The control plane VCN 1316 may allow users of the service tenancy 1319 to set up or otherwise provision desired resources. Desired resources provisioned in the control plane VCN 1316 may be deployed or otherwise used in the data plane VCN 1318. In some examples, the control plane VCN 1316 can be isolated from the data plane VCN 1318, and the data plane mirror app tier 1340 of the control plane VCN 1316 can communicate with the data plane app tier 1346 of the data plane VCN 1318 via VNICs 1342 that can be contained in the data plane mirror app tier 1340 and the data plane app tier 1346.

In some examples, users of the system, or customers, can make requests, for example create, read, update, or delete (CRUD) operations, through public Internet 1354 that can communicate the requests to the metadata management service 1352. The metadata management service 1352 can communicate the request to the control plane VCN 1316 through the Internet gateway 1334. The request can be received by the LB subnet(s) 1322 contained in the control plane DMZ tier 1320. The LB subnet(s) 1322 may determine that the request is valid, and in response to this determination, the LB subnet(s) 1322 can transmit the request to app subnet(s) 1326 contained in the control plane app tier 1324. If the request is validated and requires a call to public Internet 1354, the call to public Internet 1354 may be transmitted to the NAT gateway 1338 that can make the call to public Internet 1354. Metadata that may be desired to be stored by the request can be stored in the DB subnet(s) 1330.

In some examples, the data plane mirror app tier 1340 can facilitate direct communication between the control plane VCN 1316 and the data plane VCN 1318. For example, changes, updates, or other suitable modifications to configuration may be desired to be applied to the resources contained in the data plane VCN 1318. Via a VNIC 1342, the control plane VCN 1316 can directly communicate with, and can thereby execute the changes, updates, or other suitable modifications to configuration to, resources contained in the data plane VCN 1318.

In some embodiments, the control plane VCN 1316 and the data plane VCN 1318 can be contained in the service tenancy 1319. In this case, the user, or the customer, of the system may not own or operate either the control plane VCN 1316 or the data plane VCN 1318. Instead, the IaaS provider may own or operate the control plane VCN 1316 and the data plane VCN 1318, both of which may be contained in the service tenancy 1319. This embodiment can enable isolation of networks that may prevent users or customers from interacting with other users', or other customers', resources. Also, this embodiment may allow users or customers of the system to store databases privately without needing to rely on public Internet 1354, which may not have a desired level of threat prevention, for storage.

In other embodiments, the LB subnet(s) 1322 contained in the control plane VCN 1316 can be configured to receive a signal from the service gateway 1336. In this embodiment, the control plane VCN 1316 and the data plane VCN 1318 may be configured to be called by a customer of the IaaS provider without calling public Internet 1354. Customers of the IaaS provider may desire this embodiment since database(s) that the customers use may be controlled by the IaaS provider and may be stored on the service tenancy 1319, which may be isolated from public Internet 1354.

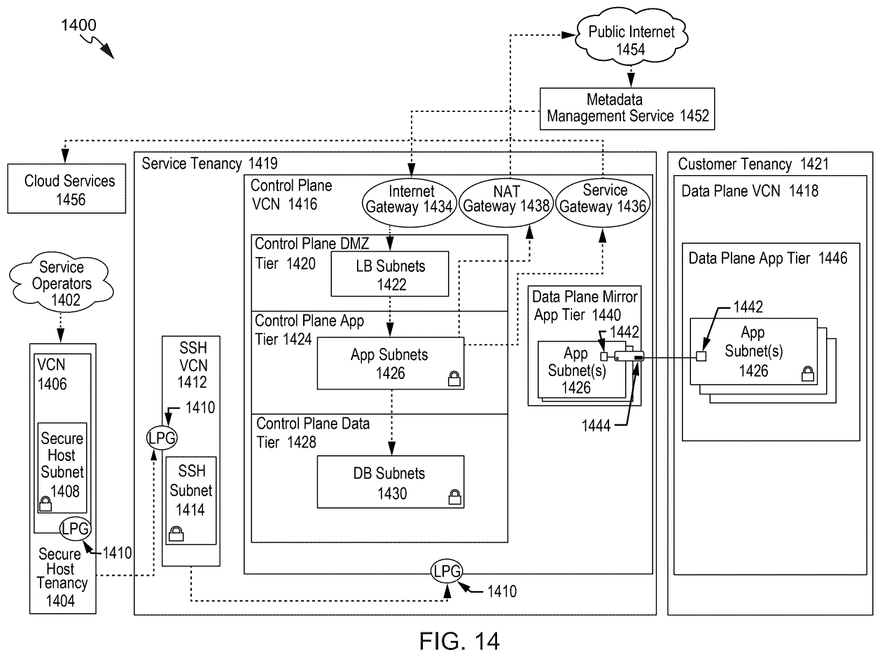

FIG. 14 is a block diagram 1400 illustrating another example pattern of an IaaS architecture, according to at least one embodiment. Service operators 1402 (e.g., service operators 1302 of FIG. 13) can be communicatively coupled to a secure host tenancy 1404 (e.g., the secure host tenancy 1304 of FIG. 13) that can include a virtual cloud network (VCN) 1406 (e.g., the VCN 1306 of FIG. 13) and a secure host subnet 1408 (e.g., the secure host subnet 1308 of FIG. 13). The VCN 1406 can include a local peering gateway (LPG) 1410 (e.g., the LPG 1310 of FIG. 13) that can be communicatively coupled to a secure shell (SSH) VCN 1412 (e.g., the SSH VCN 1312 of FIG. 13) via an LPG 1310 contained in the SSH VCN 1412. The SSH VCN 1412 can include an SSH subnet 1414 (e.g., the SSH subnet 1314 of FIG. 13), and the SSH VCN 1412 can be communicatively coupled to a control plane VCN 1416 (e.g., the control plane VCN 1316 of FIG. 13) via an LPG 1410 contained in the control plane VCN 1416. The control plane VCN 1416 can be contained in a service tenancy 1419 (e.g., the service tenancy 1319 of FIG. 13), and the data plane VCN 1418 (e.g., the data plane VCN 1318 of FIG. 13) can be contained in a customer tenancy 1421 that may be owned or operated by users, or customers, of the system.

The control plane VCN 1416 can include a control plane DMZ tier 1420 (e.g., the control plane DMZ tier 1320 of FIG. 13) that can include LB subnet(s) 1422 (e.g., LB subnet(s) 1322 of FIG. 13), a control plane app tier 1424 (e.g., the control plane app tier 1324 of FIG. 13) that can include app subnet(s) 1426 (e.g., app subnet(s) 1326 of FIG. 13), a control plane data tier 1428 (e.g., the control plane data tier 1328 of FIG. 13) that can include database (DB) subnet(s) 1430 (e.g., similar to DB subnet(s) 1330 of FIG. 13). The LB subnet(s) 1422 contained in the control plane DMZ tier 1420 can be communicatively coupled to the app subnet(s) 1426 contained in the control plane app tier 1424 and an Internet gateway 1434 (e.g., the Internet gateway 1334 of FIG. 13) that can be contained in the control plane VCN 1416, and the app subnet(s) 1426 can be communicatively coupled to the DB subnet(s) 1430 contained in the control plane data tier 1428 and a service gateway 1436 (e.g., the service gateway 1336 of FIG. 13) and a network address translation (NAT) gateway 1438 (e.g., the NAT gateway 1338 of FIG. 13). The control plane VCN 1416 can include the service gateway 1436 and the NAT gateway 1438.

The control plane VCN 1416 can include a data plane mirror app tier 1440 (e.g., the data plane mirror app tier 1340 of FIG. 13) that can include app subnet(s) 1426. The app subnet(s) 1426 contained in the data plane mirror app tier 1440 can include a virtual network interface controller (VNIC) 1442 (e.g., the VNIC of 1342) that can execute a compute instance 1444 (e.g., similar to the compute instance 1344 of FIG. 13). The compute instance 1444 can facilitate communication between the app subnet(s) 1426 of the data plane mirror app tier 1440 and the app subnet(s) 1426 that can be contained in a data plane app tier 1446 (e.g., the data plane app tier 1346 of FIG. 13) via the VNIC 1442 contained in the data plane mirror app tier 1440 and the VNIC 1442 contained in the data plane app tier 1446.

The Internet gateway 1434 contained in the control plane VCN 1416 can be communicatively coupled to a metadata management service 1452 (e.g., the metadata management service 1352 of FIG. 13) that can be communicatively coupled to public Internet 1454 (e.g., public Internet 1354 of FIG. 13). Public Internet 1454 can be communicatively coupled to the NAT gateway 1438 contained in the control plane VCN 1416. The service gateway 1436 contained in the control plane VCN 1416 can be communicatively coupled to cloud services 1456 (e.g., cloud services 1356 of FIG. 13).

In some examples, the data plane VCN 1418 can be contained in the customer tenancy 1421. In this case, the IaaS provider may provide the control plane VCN 1416 for each customer, and the IaaS provider may, for each customer, set up a unique compute instance 1444 that is contained in the service tenancy 1419. Each compute instance 1444 may allow communication between the control plane VCN 1416, contained in the service tenancy 1419, and the data plane VCN 1418 that is contained in the customer tenancy 1421. The compute instance 1444 may allow resources, that are provisioned in the control plane VCN 1416 that is contained in the service tenancy 1419, to be deployed or otherwise used in the data plane VCN 1418 that is contained in the customer tenancy 1421.

In other examples, the customer of the IaaS provider may have databases that live in the customer tenancy 1421. In this example, the control plane VCN 1416 can include the data plane mirror app tier 1440 that can include app subnet(s) 1426. The data plane mirror app tier 1440 can reside in the data plane VCN 1418, but the data plane mirror app tier 1440 may not live in the data plane VCN 1418. That is, the data plane mirror app tier 1440 may have access to the customer tenancy 1421, but the data plane mirror app tier 1440 may not exist in the data plane VCN 1418 or be owned or operated by the customer of the IaaS provider. The data plane mirror app tier 1440 may be configured to make calls to the data plane VCN 1418 but may not be configured to make calls to any entity contained in the control plane VCN 1416. The customer may desire to deploy or otherwise use resources in the data plane VCN 1418 that are provisioned in the control plane VCN 1416, and the data plane mirror app tier 1440 can facilitate the desired deployment, or other usage of resources, of the customer.

In some embodiments, the customer of the IaaS provider can apply filters to the data plane VCN 1418. In this embodiment, the customer can determine what the data plane VCN 1418 can access, and the customer may restrict access to public Internet 1454 from the data plane VCN 1418. The IaaS provider may not be able to apply filters or otherwise control access of the data plane VCN 1418 to any outside networks or databases. Applying filters and controls by the customer onto the data plane VCN 1418, contained in the customer tenancy 1421, can help isolate the data plane VCN 1418 from other customers and from public Internet 1454.

In some embodiments, cloud services 1456 can be called by the service gateway 1436 to access services that may not exist on public Internet 1454, on the control plane VCN 1416, or on the data plane VCN 1418. The connection between cloud services 1456 and the control plane VCN 1416 or the data plane VCN 1418 may not be live or continuous. Cloud services 1456 may exist on a different network owned or operated by the IaaS provider. Cloud services 1456 may be configured to receive calls from the service gateway 1436 and may be configured to not receive calls from public Internet 1454. Some cloud services 1456 may be isolated from other cloud services 1456, and the control plane VCN 1416 may be isolated from cloud services 1456 that may not be in the same region as the control plane VCN 1416. For example, the control plane VCN 1416 may be located in “Region 1,” and cloud service “Deployment 13,” may be located in Region 1 and in “Region 2.” If a call to Deployment 13 is made by the service gateway 1436 contained in the control plane VCN 1416 located in Region 1, the call may be transmitted to Deployment 13 in Region 1. In this example, the control plane VCN 1416, or Deployment 13 in Region 1, may not be communicatively coupled to, or otherwise in communication with, Deployment 13 in Region 2.

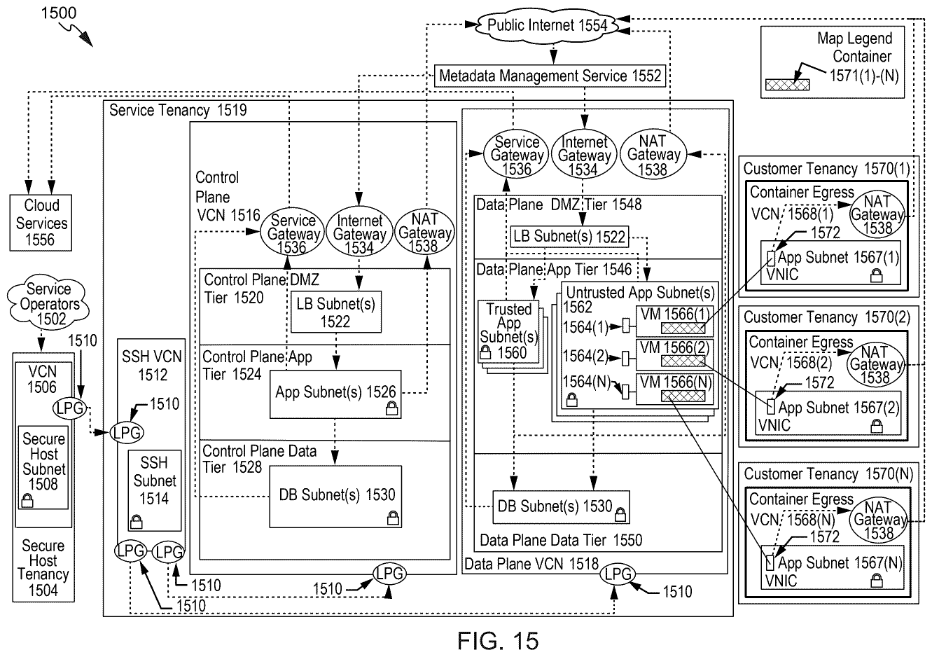

FIG. 15 is a block diagram 1500 illustrating another example pattern of an IaaS architecture, according to at least one embodiment. Service operators 1502 (e.g., service operators 1302 of FIG. 13) can be communicatively coupled to a secure host tenancy 1504 (e.g., the secure host tenancy 1304 of FIG. 13) that can include a virtual cloud network (VCN) 1506 (e.g., the VCN 1306 of FIG. 13) and a secure host subnet 1508 (e.g., the secure host subnet 1308 of FIG. 13). The VCN 1506 can include an LPG 1510 (e.g., the LPG 1310 of FIG. 13) that can be communicatively coupled to an SSH VCN 1512 (e.g., the SSH VCN 1312 of FIG. 13) via an LPG 1510 contained in the SSH VCN 1512. The SSH VCN 1512 can include an SSH subnet 1514 (e.g., the SSH subnet 1314 of FIG. 13), and the SSH VCN 1512 can be communicatively coupled to a control plane VCN 1516 (e.g., the control plane VCN 1316 of FIG. 13) via an LPG 1510 contained in the control plane VCN 1516 and to a data plane VCN 1518 (e.g., the data plane 1318 of FIG. 13) via an LPG 1510 contained in the data plane VCN 1518. The control plane VCN 1516 and the data plane VCN 1518 can be contained in a service tenancy 1519 (e.g., the service tenancy 1319 of FIG. 13).

The control plane VCN 1516 can include a control plane DMZ tier 1520 (e.g., the control plane DMZ tier 1320 of FIG. 13) that can include load balancer (LB) subnet(s) 1522 (e.g., LB subnet(s) 1322 of FIG. 13), a control plane app tier 1524 (e.g., the control plane app tier 1324 of FIG. 13) that can include app subnet(s) 1526 (e.g., similar to app subnet(s) 1326 of FIG. 13), a control plane data tier 1528 (e.g., the control plane data tier 1328 of FIG. 13) that can include DB subnet(s) 1530. The LB subnet(s) 1522 contained in the control plane DMZ tier 1520 can be communicatively coupled to the app subnet(s) 1526 contained in the control plane app tier 1524 and to an Internet gateway 1534 (e.g., the Internet gateway 1334 of FIG. 13) that can be contained in the control plane VCN 1516, and the app subnet(s) 1526 can be communicatively coupled to the DB subnet(s) 1530 contained in the control plane data tier 1528 and to a service gateway 1536 (e.g., the service gateway of FIG. 13) and a network address translation (NAT) gateway 1538 (e.g., the NAT gateway 1338 of FIG. 13). The control plane VCN 1516 can include the service gateway 1536 and the NAT gateway 1538.

The data plane VCN 1518 can include a data plane app tier 1546 (e.g., the data plane app tier 1346 of FIG. 13), a data plane DMZ tier 1548 (e.g., the data plane DMZ tier 1348 of FIG. 13), and a data plane data tier 1550 (e.g., the data plane data tier 1350 of FIG. 13). The data plane DMZ tier 1548 can include LB subnet(s) 1522 that can be communicatively coupled to trusted app subnet(s) 1560 and untrusted app subnet(s) 1562 of the data plane app tier 1546 and the Internet gateway 1534 contained in the data plane VCN 1518. The trusted app subnet(s) 1560 can be communicatively coupled to the service gateway 1536 contained in the data plane VCN 1518, the NAT gateway 1538 contained in the data plane VCN 1518, and DB subnet(s) 1530 contained in the data plane data tier 1550. The untrusted app subnet(s) 1562 can be communicatively coupled to the service gateway 1536 contained in the data plane VCN 1518 and DB subnet(s) 1530 contained in the data plane data tier 1550. The data plane data tier 1550 can include DB subnet(s) 1530 that can be communicatively coupled to the service gateway 1536 contained in the data plane VCN 1518.

The untrusted app subnet(s) 1562 can include one or more primary VNICs 1564(1)-(N) that can be communicatively coupled to tenant virtual machines (VMs) 1566(1)-(N). Each tenant VM 1566(1)-(N) can be communicatively coupled to a respective app subnet 1567(1)-(N) that can be contained in respective container egress VCNs 1568(1)-(N) that can be contained in respective customer tenancies 1570(1)-(N). Respective secondary VNICs 1572(1)-(N) can facilitate communication between the untrusted app subnet(s) 1562 contained in the data plane VCN 1518 and the app subnet contained in the container egress VCNs 1568(1)-(N). Each container egress VCNs 1568(1)-(N) can include a NAT gateway 1538 that can be communicatively coupled to public Internet 1554 (e.g., public Internet 1354 of FIG. 13).

The Internet gateway 1534 contained in the control plane VCN 1516 and contained in the data plane VCN 1518 can be communicatively coupled to a metadata management service 1552 (e.g., the metadata management system 1352 of FIG. 13) that can be communicatively coupled to public Internet 1554. Public Internet 1554 can be communicatively coupled to the NAT gateway 1538 contained in the control plane VCN 1516 and contained in the data plane VCN 1518. The service gateway 1536 contained in the control plane VCN 1516 and contained in the data plane VCN 1518 can be communicatively coupled to cloud services 1556.

In some embodiments, the data plane VCN 1518 can be integrated with customer tenancies 1570. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1546. Code to run the function may be executed in the VMs 1566(1)-(N), and the code may not be configured to run anywhere else on the data plane VCN 1518. Each VM 1566(1)-(N) may be connected to one customer tenancy 1570. Respective containers 1571(1)-(N) contained in the VMs 1566(1)-(N) may be configured to run the code. In this case, there can be a dual isolation (e.g., the containers 1571(1)-(N) running code, where the containers 1571(1)-(N) may be contained in at least the VM 1566(1)-(N) that are contained in the untrusted app subnet(s) 1562), which may help prevent incorrect or otherwise undesirable code from damaging the network of the IaaS provider or from damaging a network of a different customer. The containers 1571(1)-(N) may be communicatively coupled to the customer tenancy 1570 and may be configured to transmit or receive data from the customer tenancy 1570. The containers 1571(1)-(N) may not be configured to transmit or receive data from any other entity in the data plane VCN 1518. Upon completion of running the code, the IaaS provider may kill or otherwise dispose of the containers 1571(1)-(N).

In some embodiments, the trusted app subnet(s) 1560 may run code that may be owned or operated by the IaaS provider. In this embodiment, the trusted app subnet(s) 1560 may be communicatively coupled to the DB subnet(s) 1530 and be configured to execute CRUD operations in the DB subnet(s) 1530. The untrusted app subnet(s) 1562 may be communicatively coupled to the DB subnet(s) 1530, but in this embodiment, the untrusted app subnet(s) may be configured to execute read operations in the DB subnet(s) 1530. The containers 1571(1)-(N) that can be contained in the VM 1566(1)-(N) of each customer and that may run code from the customer may not be communicatively coupled with the DB subnet(s) 1530.

In other embodiments, the control plane VCN 1516 and the data plane VCN 1518 may not be directly communicatively coupled. In this embodiment, there may be no direct communication between the control plane VCN 1516 and the data plane VCN 1518. However, communication can occur indirectly through at least one method. An LPG 1510 may be established by the IaaS provider that can facilitate communication between the control plane VCN 1516 and the data plane VCN 1518. In another example, the control plane VCN 1516 or the data plane VCN 1518 can make a call to cloud services 1556 via the service gateway 1536. For example, a call to cloud services 1556 from the control plane VCN 1516 can include a request for a service that can communicate with the data plane VCN 1518.

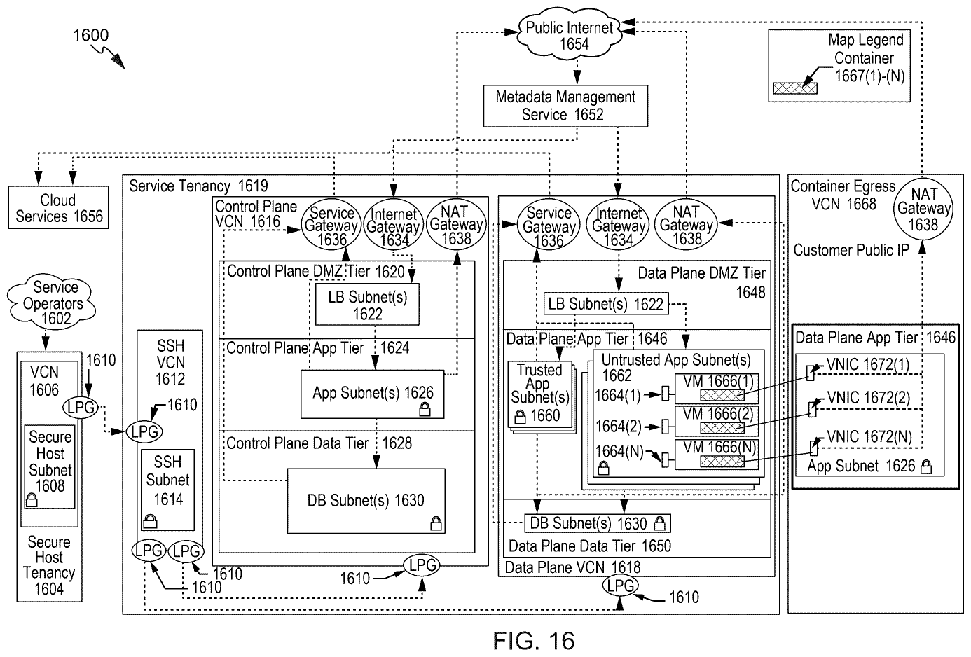

FIG. 16 is a block diagram 1600 illustrating another example pattern of an IaaS architecture, according to at least one embodiment. Service operators 1602 (e.g., service operators 1302 of FIG. 13) can be communicatively coupled to a secure host tenancy 1604 (e.g., the secure host tenancy 1304 of FIG. 13) that can include a virtual cloud network (VCN) 1606 (e.g., the VCN 1306 of FIG. 13) and a secure host subnet 1608 (e.g., the secure host subnet 1308 of FIG. 13). The VCN 1606 can include an LPG 1610 (e.g., the LPG 1310 of FIG. 13) that can be communicatively coupled to an SSH VCN 1612 (e.g., the SSH VCN 1312 of FIG. 13) via an LPG 1610 contained in the SSH VCN 1612. The SSH VCN 1612 can include an SSH subnet 1614 (e.g., the SSH subnet 1314 of FIG. 13), and the SSH VCN 1612 can be communicatively coupled to a control plane VCN 1616 (e.g., the control plane VCN 1316 of FIG. 13) via an LPG 1610 contained in the control plane VCN 1616 and to a data plane VCN 1618 (e.g., the data plane 1318 of FIG. 13) via an LPG 1610 contained in the data plane VCN 1618. The control plane VCN 1616 and the data plane VCN 1618 can be contained in a service tenancy 1619 (e.g., the service tenancy 1319 of FIG. 13).

The control plane VCN 1616 can include a control plane DMZ tier 1620 (e.g., the control plane DMZ tier 1320 of FIG. 13) that can include LB subnet(s) 1622 (e.g., LB subnet(s) 1322 of FIG. 13), a control plane app tier 1624 (e.g., the control plane app tier 1324 of FIG. 13) that can include app subnet(s) 1626 (e.g., app subnet(s) 1326 of FIG. 13), a control plane data tier 1628 (e.g., the control plane data tier 1328 of FIG. 13) that can include DB subnet(s) 1630 (e.g., DB subnet(s) 1530 of FIG. 15). The LB subnet(s) 1622 contained in the control plane DMZ tier 1620 can be communicatively coupled to the app subnet(s) 1626 contained in the control plane app tier 1624 and to an Internet gateway 1634 (e.g., the Internet gateway 1334 of FIG. 13) that can be contained in the control plane VCN 1616, and the app subnet(s) 1626 can be communicatively coupled to the DB subnet(s) 1630 contained in the control plane data tier 1628 and to a service gateway 1636 (e.g., the service gateway of FIG. 13) and a network address translation (NAT) gateway 1638 (e.g., the NAT gateway 1338 of FIG. 13). The control plane VCN 1616 can include the service gateway 1636 and the NAT gateway 1638.

The data plane VCN 1618 can include a data plane app tier 1646 (e.g., the data plane app tier 1346 of FIG. 13), a data plane DMZ tier 1648 (e.g., the data plane DMZ tier 1348 of FIG. 13), and a data plane data tier 1650 (e.g., the data plane data tier 1350 of FIG. 13). The data plane DMZ tier 1648 can include LB subnet(s) 1622 that can be communicatively coupled to trusted app subnet(s) 1660 (e.g., trusted app subnet(s) 1560 of FIG. 15) and untrusted app subnet(s) 1662 (e.g., untrusted app subnet(s) 1562 of FIG. 15) of the data plane app tier 1646 and the Internet gateway 1634 contained in the data plane VCN 1618. The trusted app subnet(s) 1660 can be communicatively coupled to the service gateway 1636 contained in the data plane VCN 1618, the NAT gateway 1638 contained in the data plane VCN 1618, and DB subnet(s) 1630 contained in the data plane data tier 1650. The untrusted app subnet(s) 1662 can be communicatively coupled to the service gateway 1636 contained in the data plane VCN 1618 and DB subnet(s) 1630 contained in the data plane data tier 1650. The data plane data tier 1650 can include DB subnet(s) 1630 that can be communicatively coupled to the service gateway 1636 contained in the data plane VCN 1618.

The untrusted app subnet(s) 1662 can include primary VNICs 1664(1)-(N) that can be communicatively coupled to tenant virtual machines (VMs) 1666(1)-(N) residing within the untrusted app subnet(s) 1662. Each tenant VM 1666(1)-(N) can run code in a respective container 1667(1)-(N), and be communicatively coupled to an app subnet 1626 that can be contained in a data plane app tier 1646 that can be contained in a container egress VCN 1668. Respective secondary VNICs 1672(1)-(N) can facilitate communication between the untrusted app subnet(s) 1662 contained in the data plane VCN 1618 and the app subnet contained in the container egress VCN 1668. The container egress VCN can include a NAT gateway 1638 that can be communicatively coupled to public Internet 1654 (e.g., public Internet 1354 of FIG. 13).

The Internet gateway 1634 contained in the control plane VCN 1616 and contained in the data plane VCN 1618 can be communicatively coupled to a metadata management service 1652 (e.g., the metadata management system 1352 of FIG. 13) that can be communicatively coupled to public Internet 1654. Public Internet 1654 can be communicatively coupled to the NAT gateway 1638 contained in the control plane VCN 1616 and contained in the data plane VCN 1618. The service gateway 1636 contained in the control plane VCN 1616 and contained in the data plane VCN 1618 can be communicatively coupled to cloud services 1656.

In some examples, the pattern illustrated by the architecture of block diagram 1600 of FIG. 16 may be considered an exception to the pattern illustrated by the architecture of block diagram 1500 of FIG. 15 and may be desirable for a customer of the IaaS provider if the IaaS provider cannot directly communicate with the customer (e.g., a disconnected region). The respective containers 1667(1)-(N) that are contained in the VMs 1666(1)-(N) for each customer can be accessed in real-time by the customer. The containers 1667(1)-(N) may be configured to make calls to respective secondary VNICs 1672(1)-(N) contained in app subnet(s) 1626 of the data plane app tier 1646 that can be contained in the container egress VCN 1668. The secondary VNICs 1672(1)-(N) can transmit the calls to the NAT gateway 1638 that may transmit the calls to public Internet 1654. In this example, the containers 1667(1)-(N) that can be accessed in real-time by the customer can be isolated from the control plane VCN 1616 and can be isolated from other entities contained in the data plane VCN 1618. The containers 1667(1)-(N) may also be isolated from resources from other customers.

In other examples, the customer can use the containers 1667(1)-(N) to call cloud services 1656. In this example, the customer may run code in the containers 1667(1)-(N) that requests a service from cloud services 1656. The containers 1667(1)-(N) can transmit this request to the secondary VNICs 1672(1)-(N) that can transmit the request to the NAT gateway that can transmit the request to public Internet 1654. Public Internet 1654 can transmit the request to LB subnet(s) 1622 contained in the control plane VCN 1616 via the Internet gateway 1634. In response to determining the request is valid, the LB subnet(s) can transmit the request to app subnet(s) 1626 that can transmit the request to cloud services 1656 via the service gateway 1636.

It should be appreciated that IaaS architectures 1300, 1400, 1500, 1600 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

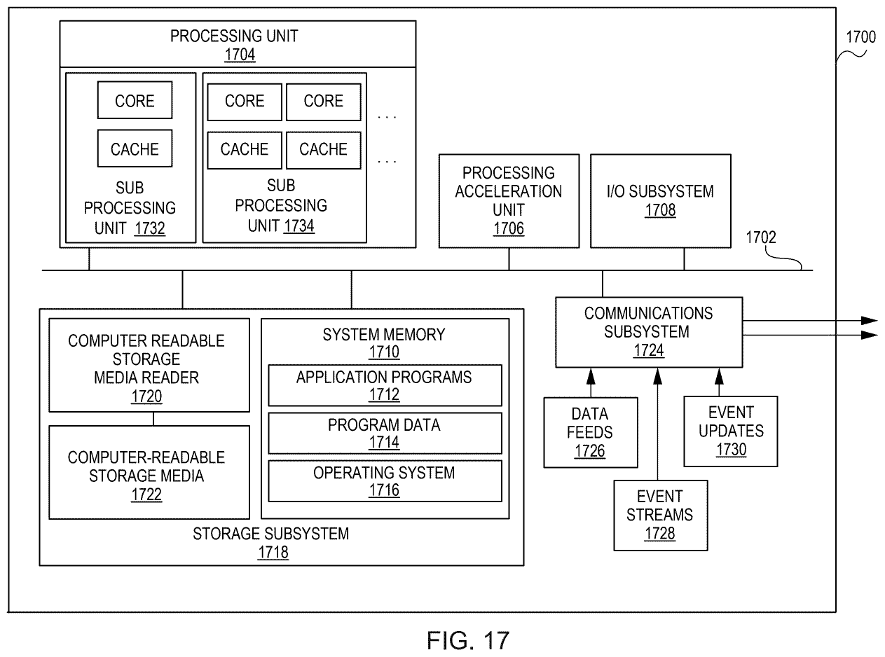

FIG. 17 illustrates an example computer system 1700, in which various embodiments may be implemented. The system 1700 may be used to implement any of the computer systems described above. As shown in the figure, computer system 1700 includes a processing unit 1704 that communicates with a number of peripheral subsystems via a bus subsystem 1702. These peripheral subsystems may include a processing acceleration unit 1706, an I/O subsystem 1708, a storage subsystem 1718 and a communications subsystem 1724. Storage subsystem 1718 includes tangible computer-readable storage media 1722 and a system memory 1710.

Bus subsystem 1702 provides a mechanism for letting the various components and subsystems of computer system 1700 communicate with each other as intended. Although bus subsystem 1702 is shown schematically as a single bus, alternative embodiments of the bus subsystem may utilize multiple buses. Bus subsystem 1702 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1704, which can be implemented as one or more integrated circuits (e.g., a conventional microprocessor or microcontroller), controls the operation of computer system 1700. One or more processors may be included in processing unit 1704. These processors may include single core or multicore processors. In certain embodiments, processing unit 1704 may be implemented as one or more independent processing units 1732 and/or 1734 with single or multicore processors included in each processing unit. In other embodiments, processing unit 1704 may also be implemented as a quad-core processing unit formed by integrating two dual-core processors into a single chip.

In various embodiments, processing unit 1704 can execute a variety of programs in response to program code and can maintain multiple concurrently executing programs or processes. At any given time, some or all of the program code to be executed can be resident in processor(s) 1704 and/or in storage subsystem 1718. Through suitable programming, processor(s) 1704 can provide various functionalities described above. Computer system 1700 may additionally include a processing acceleration unit 1706, which can include a digital signal processor (DSP), a special-purpose processor, and/or the like.

I/O subsystem 1708 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1700 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1700 may comprise a storage subsystem 1718 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1704 provide the functionality described above. Storage subsystem 1718 may also provide a repository for storing data used in accordance with the present disclosure.

As depicted in the example in FIG. 17, storage subsystem 1718 can include various components including a system memory 1710, computer-readable storage media 1722, and a computer readable storage media reader 1720. System memory 1710 may store program instructions that are loadable and executable by processing unit 1704. System memory 1710 may also store data that is used during the execution of the instructions and/or data that is generated during the execution of the program instructions. Various different kinds of programs may be loaded into system memory 1710 including but not limited to client applications, Web browsers, mid-tier applications, relational database management systems (RDBMS), virtual machines, containers, etc.

System memory 1710 may also store an operating system 1716. Examples of operating system 1716 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1700 executes one or more virtual machines, the virtual machines along with their guest operating systems (GOSs) may be loaded into system memory 1710 and executed by one or more processors or cores of processing unit 1704.

System memory 1710 can come in different configurations depending upon the type of computer system 1700. For example, system memory 1710 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1710 may include a basic input/output system (BIOS) containing basic routines that help to transfer information between elements within computer system 1700, such as during start-up.

Computer-readable storage media 1722 may represent remote, local, fixed, and/or removable storage devices plus storage media for temporarily and/or more permanently containing, storing, computer-readable information for use by computer system 1700 including instructions executable by processing unit 1704 of computer system 1700.

Computer-readable storage media 1722 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1722 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1722 may include, but is not limited to, Zip® drives, flash memory cards, universal serial bus (USB) flash drives, secure digital (SD) cards, DVD disks, digital video tape, and the like. Computer-readable storage media 1722 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1700.

Machine-readable instructions executable by one or more processors or cores of processing unit 1704 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1724 provides an interface to other computer systems and networks. Communications subsystem 1724 serves as an interface for receiving data from and transmitting data to other systems from computer system 1700. For example, communications subsystem 1724 may enable computer system 1700 to connect to one or more devices via the Internet. In some embodiments communications subsystem 1724 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1724 can provide wired network connectivity (e.g., Ethernet) in addition to or instead of a wireless interface.

In some embodiments, communications subsystem 1724 may also receive input communication in the form of structured and/or unstructured data feeds 1726, event streams 1728, event updates 1730, and the like on behalf of one or more users who may use computer system 1700.

By way of example, communications subsystem 1724 may be configured to receive data feeds 1726 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1724 may also be configured to receive data in the form of continuous data streams, which may include event streams 1728 of real-time events and/or event updates 1730, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1724 may also be configured to output the structured and/or unstructured data feeds 1726, event streams 1728, event updates 1730, and the like to one or more databases that may be in communication with one or more streaming data source computers coupled to computer system 1700.

Computer system 1700 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1700 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed:

1. A computer-implemented method comprising:
(a) generating, by a first generative artificial intelligence model, keyphrases for a domain;
(b) generating entities and associated normalized forms;
(c) generating, by a second generative artificial intelligence model, text scripts for the domain based on the keyphrases and the entities and their associated normalized forms;
(d) generating, by one or more audio models, audio associated with each of the text scripts; and
(e) training, using the text scripts and the audio associated with each of the text scripts, one or more machine learning models.

2. The computer-implemented method of claim 1, wherein generating the key phrases is an iterative process that comprises:
determining whether a required number of keyphrases are available in a keyphrase store based on a current number or size of keyphrases stored in the keyphrase store and a predetermined threshold number or size of keyphrases to be generated and collected;
when the required number of keyphrases are unavailable in the keyphrase store, generating, by the first generative artificial intelligence model, a keyphrase for the domain using multistep conversational prompting;
evaluating a similarity of the keyphrase with each of the keyphrases stored in the keyphrase store;
when the keyphrase is not similar to the keyphrases stored in the keyphrase store based on the evaluating, storing the keyphrase in the keyphrase store; and
when the keyphrase is similar to at least one of the keyphrases stored in the keyphrase store based on the evaluating, skipping the keyphrase and proceeding back to generating, by the first generative artificial intelligence model, a keyphrase for the domain using the multistep conversational prompting.

3. The computer-implemented method of claim 1, wherein generating the entities and the associated normalized forms is an iterative process that comprises:
determining whether a required number of entities have been generated based on an entity counter and a predetermined threshold number of entities to be generated and collected;
when the required number of entities have not been generated, sampling an entity from a list of possible entities;
identifying a type of semiotic entity required for the sampled entity;
executing an entity provider associated with the type of semiotic entity required for the sampled entity, wherein the executing comprises generating a semiotic entity and a corresponding normalized form of the semiotic entity deterministically using a set of rules and one or more algorithms; and
increasing the entity counter by one.

4. The computer-implemented method of claim 1, wherein the text scripts are generated by combining one or more of the keyphrases with one or more of the entities and forcing the second generative artificial intelligence model to generate the text scripts in a predefined type and format using a custom prompt for the predefined type and a library enforcer for the predefined format.

5. The computer-implemented method of claim 4, further comprising:
replacing the entities in the text scripts with the normalized forms associated with each of the entities; and
normalizing, by a language model, any new entities within the text scripts that were generated by the second generative artificial intelligence model during the process of generating the text scripts.

6. The computer-implemented method of claim 1, further comprising:
determining whether a required number of the text scripts and the audio associated with each of the text scripts have been generated and collected for training the one or more machine learning models based on a datapoint counter and a predetermined threshold number of datapoints;
when the required number of the text scripts and the audio associated with each of the text scripts have not been generated, generating additional text scripts and audio associated with each of the additional text scripts by executing steps (a)-(d) for the same domain or a different domain and increasing the datapoint counter by one for each additional text script and associated audio that is generated;
when the required number of the text scripts and the audio associated with each of the text scripts have been generated, training, using the text scripts and the audio associated with each of the text scripts, the one or more machine learning models;
prior to generating the audio associated with each of the text scripts, determining a validity of each of the text scripts based on integrity checks;
when a text script is invalid based on the validity determination, the text script is removed from the method; and
when the text script is valid based on the validity determination, the text script is kept in the method and the audio associated with text script is generated.

7. The computer-implemented method of claim 1, wherein generating the audio associated with each of the text scripts comprises:
determining whether voice styling is needed based on defined configurations;
when voice styling is needed, generating, by an audio styling model of the one or more audio models, the audio associated with each of the text scripts in the defined style and language;
when voice styling is not needed, generating, by a base language audio model of the one or more audio models, the audio associated with each of the text scripts;
determining whether voice cloning is needed based on defined configurations;
when voice cloning is needed, cloning, by a cloning model of the one or more audio models and using a reference audio, a voice and modifying the audio associated with each of the text scripts in the defined style and language based on the cloned voice, and proceeding to perform step (e) using the text scripts and the audio with the cloned voice and with or without voice styling associated with each of the text scripts; and
when voice cloning is not needed, proceeding to perform step (e) using the text scripts and the audio with or without voice styling associated with each of the text scripts.

8. A system comprising:
one or more processors;
a memory coupled to the one or more processors, the memory storing a plurality of instructions executable by the one or more processors, the plurality of instructions comprising instructions that when executed by the one or more processors cause the one or more processors to perform operations comprising:
(a) generating, by a first generative artificial intelligence model, keyphrases for a domain;
(b) generating entities and associated normalized forms;
(c) generating, by a second generative artificial intelligence model, text scripts for the domain based on the keyphrases and the entities and their associated normalized forms;
(d) generating, by one or more audio models, audio associated with each of the text scripts; and
(e) training, using the text scripts and the audio associated with each of the text scripts, one or more machine learning models.

9. The system of claim 8, wherein generating the key phrases is an iterative process that comprises:
determining whether a required number of keyphrases are available in a keyphrase store based on a current number or size of keyphrases stored in the keyphrase store and a predetermined threshold number or size of keyphrases to be generated and collected;
when the required number of keyphrases are unavailable in the keyphrase store, generating, by the first generative artificial intelligence model, a keyphrase for the domain using multistep conversational prompting;
evaluating a similarity of the keyphrase with each of the keyphrases stored in the keyphrase store;
when the keyphrase is not similar to the keyphrases stored in the keyphrase store based on the evaluating, storing the keyphrase in the keyphrase store; and
when the keyphrase is similar to at least one of the keyphrases stored in the keyphrase store based on the evaluating, skipping the keyphrase and proceeding back to generating, by the first generative artificial intelligence model, a keyphrase for the domain using the multistep conversational prompting.

10. The system of claim 8, wherein generating the entities and the associated normalized forms is an iterative process that comprises:
determining whether a required number of entities have been generated based on an entity counter and a predetermined threshold number of entities to be generated and collected;
when the required number of entities have not been generated, sampling an entity from a list of possible entities;
identifying a type of semiotic entity required for the sampled entity;
executing an entity provider associated with the type of semiotic entity required for the sampled entity, wherein the executing comprises generating a semiotic entity and a corresponding normalized form of the semiotic entity deterministically using a set of rules and one or more algorithms; and
increasing the entity counter by one.

11. The system of claim 8, wherein the text scripts are generated by combining one or more of the keyphrases with one or more of the entities and forcing the second generative artificial intelligence model to generate the text scripts in a predefined type and format using a custom prompt for the predefined type and a library enforcer for the predefined format.

12. The system of claim 11, wherein the operations further comprise:
replacing the entities in the text scripts with the normalized forms associated with each of the entities; and
normalizing, by a language model, any new entities within the text scripts that were generated by the second generative artificial intelligence model during the process of generating the text scripts.

13. The system of claim 8, wherein the operations further comprise:
determining whether a required number of the text scripts and the audio associated with each of the text scripts have been generated and collected for training the one or more machine learning models based on a datapoint counter and a predetermined threshold number of datapoints;
when the required number of the text scripts and the audio associated with each of the text scripts have not been generated, generating additional text scripts and audio associated with each of the additional text scripts by executing steps (a)-(d) for the same domain or a different domain and increasing the datapoint counter by one for each additional text script and associated audio that is generated;
when the required number of the text scripts and the audio associated with each of the text scripts have been generated, training, using the text scripts and the audio associated with each of the text scripts, the one or more machine learning models;
prior to generating the audio associated with each of the text scripts, determining a validity of each of the text scripts based on integrity checks;
when a text script is invalid based on the validity determination, the text script is removed from the method; and
when the text script is valid based on the validity determination, the text script is kept in the method and the audio associated with text script is generated.

14. The system of claim 8, wherein generating the audio associated with each of the text scripts comprises:
determining whether voice styling is needed based on defined configurations;
when voice styling is needed, generating, by an audio styling model of the one or more audio models, the audio associated with each of the text scripts in the defined style and language;
when voice styling is not needed, generating, by a base language audio model of the one or more audio models, the audio associated with each of the text scripts;
determining whether voice cloning is needed based on defined configurations;
when voice cloning is needed, cloning, by a cloning model of the one or more audio models and using a reference audio, a voice and modifying the audio associated with each of the text scripts in the defined style and language based on the cloned voice, and proceeding to perform step (e) using the text scripts and the audio with the cloned voice and with or without voice styling associated with each of the text scripts; and
when voice cloning is not needed, proceeding to perform step (e) using the text scripts and the audio with or without voice styling associated with each of the text scripts.

15. A computer-program product tangibly embodied in a non-transitory machine-readable storage medium, including instructions configured to cause one or more data processors to perform operations comprising:
(a) generating, by a first generative artificial intelligence model, keyphrases for a domain;
(b) generating entities and associated normalized forms;
(c) generating, by a second generative artificial intelligence model, text scripts for the domain based on the keyphrases and the entities and their associated normalized forms;
(d) generating, by one or more audio models, audio associated with each of the text scripts; and
(e) training, using the text scripts and the audio associated with each of the text scripts, one or more machine learning models.

16. The computer-program product of claim 15, wherein generating the key phrases is an iterative process that comprises:
determining whether a required number of keyphrases are available in a keyphrase store based on a current number or size of keyphrases stored in the keyphrase store and a predetermined threshold number or size of keyphrases to be generated and collected;
when the required number of keyphrases are unavailable in the keyphrase store, generating, by the first generative artificial intelligence model, a keyphrase for the domain using multistep conversational prompting;
evaluating a similarity of the keyphrase with each of the keyphrases stored in the keyphrase store;
when the keyphrase is not similar to the keyphrases stored in the keyphrase store based on the evaluating, storing the keyphrase in the keyphrase store; and
when the keyphrase is similar to at least one of the keyphrases stored in the keyphrase store based on the evaluating, skipping the keyphrase and proceeding back to generating, by the first generative artificial intelligence model, a keyphrase for the domain using the multistep conversational prompting.

17. The computer-program product of claim 15, wherein generating the entities and the associated normalized forms is an iterative process that comprises:
determining whether a required number of entities have been generated based on an entity counter and a predetermined threshold number of entities to be generated and collected;
when the required number of entities have not been generated, sampling an entity from a list of possible entities;
identifying a type of semiotic entity required for the sampled entity;
executing an entity provider associated with the type of semiotic entity required for the sampled entity, wherein the executing comprises generating a semiotic entity and a corresponding normalized form of the semiotic entity deterministically using a set of rules and one or more algorithms; and
increasing the entity counter by one.

18. The computer-program product of claim 15, wherein the text scripts are generated by combining one or more of the keyphrases with one or more of the entities and forcing the second generative artificial intelligence model to generate the text scripts in a predefined type and format using a custom prompt for the predefined type and a library enforcer for the predefined format.

19. The computer-program product of claim 18, wherein the operations further comprise:
replacing the entities in the text scripts with the normalized forms associated with each of the entities; and
normalizing, by a language model, any new entities within the text scripts that were generated by the second generative artificial intelligence model during the process of generating the text scripts.

20. The computer-program product of claim 15, wherein the operations further comprise:
determining whether a required number of the text scripts and the audio associated with each of the text scripts have been generated and collected for training the one or more machine learning models based on a datapoint counter and a predetermined threshold number of datapoints;
when the required number of the text scripts and the audio associated with each of the text scripts have not been generated, generating additional text scripts and audio associated with each of the additional text scripts by executing steps (a)-(d) for the same domain or a different domain and increasing the datapoint counter by one for each additional text script and associated audio that is generated;
when the required number of the text scripts and the audio associated with each of the text scripts have been generated, training, using the text scripts and the audio associated with each of the text scripts, the one or more machine learning models;
prior to generating the audio associated with each of the text scripts, determining a validity of each of the text scripts based on integrity checks;
when a text script is invalid based on the validity determination, the text script is removed from the method; and
when the text script is valid based on the validity determination, the text script is kept in the method and the audio associated with text script is generated.
